(19) United States
(12) Patent Application Publication
(10) Pub. No.: US 2024/0251440 A1
(43) Pub. Date: Jul. 25, 2024

(54) METHODS FOR COORDINATING DEVICES OPERATING IN UNLICENSED SPECTRUM

(71) Applicant: Telefonaktiebolaget LM Ericsson (PUBL), Stockholm (SE)

(72) Inventors: Angelo Centonza, GRANADA (ES); Luca Lunardi, GENOA (IT); Reem Karaki, AACHEN (DE); Johan Rune, LIDINGÖ (SE); Marco Belleschi, SOLNA (SE); Pradeepa Ramachandra, LINKÖPING (SE)

(21) Appl. No.: 18/263,169

(22) PCT Filed: Jan. 13, 2022
(86) PCT No.: PCT/IB2022/050269

§ 371 Date: Jul. 27, 2023

(51) Int. Cl. H04W 74/0808; H04W 16/14

(52) U.S. Cl. CPC H04W 74/0808; H04W 16/14

(57) ABSTRACT

In certain embodiments, a method performed by a first radio access network (RAN) node comprises receiving, from a second RAN node, load metrics associated with a shared channel and listen-before-talk (LBT) configuration information. The LBT configuration information indicates how a determination is made whether the shared channel is occupied or available for communication between the second RAN node and a wireless device. The method further comprises performing one or more operations of the first RAN node based at least in part on the load metrics and the LBT configuration information received from the second RAN node.

### TECHNICAL FIELD

Certain embodiments relate, in general, to wireless communications, and, more particularly, to coordinating devices operating in unlicensed spectrum.

### BACKGROUND

### 5G RAN Architecture

FIG. 1 illustrates the current 5^{th} Generation (5G) Radio Access Network (RAN) architecture as depicted and described in the Third Generation Partnership Project (3GPP) Technical Specification (TS) 38.401v15.4.0. The 5G-RAN may also be referred to as a Next Generation (NG) RAN (NG-RAN). The NG architecture can be further described as follows. The NG-RAN consists of a set of gNBs (the radio base station in 5G) connected to the 5G Core network (5GC) through the NG interface. An gNB can support frequency division duplex (FDD) mode, time division duplex (TDD) mode, or dual mode operation. The gNBs can be interconnected through the Xn interface. A gNB may consist of a centralized unit (gNB-CU) and a distributed unit (gNB-DUs). A gNB-CU and a gNB-DU are connected via F1 logical interface. One gNB-DU is connected to only one gNB-CU. For resiliency, a gNB-DU may be connected to multiple gNB-CU by appropriate implementation. NG, Xn and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

A gNB may also be connected to an eNB (evolved NodeB, the radio base station in Long Term Evolution (LTE)) via the X2 interface. Another architectural option is that where an LTE eNB connected to the Evolved Packet Core (EPC) network is connected over the X2 interface with a so called nr-gNB. The latter is a gNB not connected directly to a core node (CN) and connected via X2 to an eNB for the sole purpose of performing dual connectivity.

The architecture in FIG. 1 can be expanded by spitting the gNB-CU into two entities. One that serves the user plane (gNB-CU-UP) and one that serves the control plane (gNB-CU-CP). The gNB-CU-UP hosts the Packet Data Convergence Protocol (PDCP). The gNB-CU-CP hosts the PDCP and Radio Resource Control (RRC) protocol. For completeness it should be said that a gNB-DU hosts the Radio Link Control (RLC)/Medium Access Control (MAC)/Physical Layer (PHY) protocols.

### NR in Unlicensed Spectrum (NR-U)

Currently the 5th generation of cellular system, called New Radio (NR), is being standardized in 3GPP. NR is developed for maximum flexibility to support multiple and substantially different use cases. The use cases include typical mobile broadband, machine-type communication (MTC), ultra-low latency critical communications (URLCC), and side-link device-to-device (D2D), among others.

In NR, the basic scheduling unit is called a slot. A slot consists of 14 orthogonal frequency-division multiplexing (OFDM) symbols for the normal cyclic prefix configuration. NR supports many different subcarrier spacing configurations and, at a subcarrier spacing of 30 kHz, the OFDM symbol duration is ˜33 us. As an example, a slot with 14 symbols for the same subcarrier-spacing (SCS) is 500 us long (including cyclic prefixes).

NR also supports flexible bandwidth configurations for different User Equipment (UEs) on the same serving cell. In other words, the bandwidth monitored by a UE and used for its control and data channels may be smaller than the carrier bandwidth. One or multiple bandwidth part configurations for each component carrier can be semi-statically signaled to a UE, where a bandwidth part consists of a group of contiguous physical resource blocks (PRBs). Reserved resources can be configured within the bandwidth part. The bandwidth of a bandwidth part equals to or is smaller than the maximal bandwidth capability supported by a UE.

NR is targeting both licensed and unlicensed bands. A work item named “NR-based Access to Unlicensed Spectrum (NR-U)” was started in January 2019. Allowing unlicensed networks, i.e., networks that operate in shared spectrum (or unlicensed spectrum) to effectively use the available spectrum is an attractive approach to increase system capacity. Although unlicensed spectrum does not match the qualities of the licensed regime, solutions that allow an efficient use of it as a complement to licensed deployments have the potential to bring great value to the 3GPP operators, and, ultimately, to the 3GPP industry as a whole. It is expected that some features in NR will need to be adapted to comply with the special characteristics of the unlicensed band as well as also different regulations. A subcarrier spacing of 15 or 30 kHz are the most promising candidates for NR-U OFDM numerologies for frequencies below 6 GHz.

When operating in unlicensed spectrum many regions in the world require a device to sense the medium as free before transmitting. This, operation is often referred to as listen-before-talk (LBT for short). There are many different flavors of LBT, depending on which radio technology the device uses and which type of data it wants to transmit at the moment. Common for all flavors is that the sensing is done in a particular channel (corresponding to a defined carrier frequency) and over a predefined bandwidth. For example, in the 5 GHz band, the sensing is done over 20 MHz channels.

Many devices are capable of transmitting (and receiving) over a wide bandwidth including of multiple sub-bands/channels, e.g., LBT sub-band (i.e., the frequency part with bandwidth equals to LBT bandwidth). A device is only allowed to transmit on the sub-bands where the medium is sensed as free. Again, there are different flavors of how the sensing should be done when multiple sub-bands are involved.

In principle, there are two ways a device can operate over multiple sub-bands. One way is that the transmitter/receiver bandwidth is changed depending on which sub-bands were sensed as free. In this setup, there is only one component carrier (CC) and the multiple sub-bands are treated as single channel with a larger bandwidth. The other way is that the device operates almost independent processing chains for each channel. Depending on how independent the processing chains are, this option can be referred to as either carrier aggregation (CA) or dual connectivity (DC).

### Channel Access Procedure in NR Unlicensed Spectrum

Listen-before-talk (LBT) is designed for unlicensed spectrum co-existence with other radio access technologies (RATs). In this mechanism, a radio device applies a clear channel assessment (CCA) check (i.e. channel sensing) before any transmission. The transmitter involves energy detection (ED) over a time period compared to a certain threshold (ED threshold) in order to determine if a channel is idle.

LBT parameter settings (including ED) may be set for devices in a network by a network node configuring the devices in the network. The limits may be set as pre-defined rules or tables in specifications or regulatory requirements for operation in a certain region. Such limits are part of the European Telecommunications Standards Institute (ETSI) harmonized standard in Europe as well as the 3GPP specification for operation of LTE/NR-U in unlicensed spectrum.

Further, two modes of access operations are defined—Frame-Based Equipment (FBE) and Load-Based Equipment (LBE). In FBE mode, the sensing period is simple, while the sensing scheme in LBE mode is more complex.

### Dynamic Channel Occupancy (LBE Mode)

The default LBT mechanism for LBE operation, LBT category 4, is similar to existing Wi-Fi operation, where a node can sense the channel at any time and start transmitting if the channel is free after a deferral and backoff period. For specific cases, e.g. shared Channel Occupancy Time (COT), other LBT categories allowing a very short sensing period, are allowed.

Sensing is done typically for a random number of sensing intervals with this random number being a number within the range of 0 to CW, where CW represents a contention window size. Initially, a backoff counter is initialized to this random number drawn within 0 and CW. When a busy carrier is sensed to have become idle, a device must wait for a fixed period also known as a prioritization period, after which it can sense the carrier in units of the sensing interval. For each sensing interval within which the carrier is sensed to be idle, the backoff counter is decremented. When the backoff counter reaches zero, the device can transmit on the carrier. After transmission, if a collision is detected via the reception of a negative acknowledgement or by some other means, the contention window size, CW, is doubled. As soon as the transmitter has grasped access to a channel, the transmitter is only allowed to perform transmission up to a maximum time duration (namely, the maximum channel occupancy time (MCOT)). For QoS differentiation, a channel access priority based on the service type has been defined. For example, there are four LBT priority classes are defined for differentiation of contention window sizes (CWS) and MCOT between services

### Semi-Static Channel Occupancy (FBE Mode)

In FBE mode as defined in 3GPP and illustrated in FIG. 2, the gNB assigns Fixed Frame Periods (FFP)s, senses the channel for 9 us just before the FFP boundary, and if the channel is sensed to be free, it starts with a downlink (DL) transmission, and/or allocates resources among different UEs in the FFP. This procedure can be repeated with a certain periodicity. In the FFP, downlink (DL) and/or uplink (UL) transmissions are only allowed within the COT, a subset of FFP resource, where the remaining Idle period is reserved so that other nodes also have the chance to sense and utilize the channel. Hence in FBE operations, the channel is sensed at specific intervals just before the FFP boundary. The FFP can be set to values between 1 and 10 ms and can be changed after a minimum of 200 ms. The IDLE period is a regulatory requirement and is supposed to be at least T_{IDLE}≥max(0.05*COT, 100 us). In 3GPP TS 37.213 this has been simplified to be T_{IDLE}≥max(0.05*FFP, 100 us), i.e. the maximum channel occupancy time, MCOT, would be defined as T_{MCOT}=min(0.95*FFP, FFP-0.1 ms). So for 10 ms FFP, the MCOT would be 9.5 ms, while for 1 ms FFP the MCOT would be 0.9 ms=0.9*FFP.

### Basic of Mobility Load Balancing (MLB) in LTE

In mobile networks, the load of a radio access node is constantly measured so that when it gets above a pre-configure threshold, procedures can be triggered so that part of this load is transferred to either a neighbor cell of the same radio access technology (RAT) or another RAT or frequency.

The set of procedures to support this transfer is called mobility load balancing (MLB). Currently, 3GPP specifies the following components for the MLB solution:
Load reporting
Load balancing action based on handovers (HO)s
Adapting HO/cell reselection (CR) configuration so that the load remains balanced.

For LTE, the load reporting function is executed by exchanging cell specific load information between neighbor enhanced NodeBs (eNBs) over the X2 (intra-LTE scenario) or S1 (inter-RAT scenario) interfaces. In the case of intra-LTE load balance, the source eNB may trigger a RESOURCE_STATUS_REQUEST message to potential target eNBs at any point in time, for example when the load is above a pre-defined value i.e. Lte_load_threshold, as shown in FIG. 3. Upon successful configuration of resource status reports from target to source, the target eNB can respond (periodically or not) with a RESOURCE_STATUS_UPDATE containing information about its load per cell. The message exchange is highlighted in FIG. 5, which is further discussed below.

FIG. 4 illustrates X2 Load exchange procedures for MLB. A mobility load balancing algorithm running at a radio access node (for example, an eNB) has to decide which UE's will be handed over (a process called UE selection) and to which neighbor cells (a process called cell selection). These decisions are typically taken based mainly on the load reports and potentially available radio measurements of source cell and neighbor cells reported by the UE candidates. More details about UE/cell selection processes are given later.

In other words, the UE may send measurement reports (Reference Signal Received Power (RSRP), Reference Signal Received Quality (RSRQ), Signal-to-Interference-Plus-Noise Ratio (SINR), etc.) for a given neighbor cell (e.g. cell-2 in eNB-2) and, upon the reception of these and having load information of such neighbor cell the source may decide to handover the UE to the neighbor cell due to overload or not. In this case an handover preparation is triggered towards a target node, e.g. eNB-2.

As part of Resource Status Reporting procedure, a first eNB sending load information to a second eNB can include an indication (such as Cell Reporting Indicator) to indicate to the second eNB node that the ongoing transfer of load information has to be stopped. This may be used, e.g. as an indication that the load in the first eNB has become excessive.

Another procedure that may be executed is a Mobility Setting Change. The Mobility Setting Change procedure can be run before or after a MLB handover is performed. This procedure is aimed at negotiating between source cell and potential target cell a change on the *Handover Trigger event, which is used to trigger the mobility event from one cell to another. As an example, we can consider the case where the Mobility Setting Change is performed after the HO. Once the source eNB has selected the target eNB and which UE's will be offloaded, it performs a Mobility Setting Change Procedure (also specified by 3GPP [TS 36.423]). During this procedure, new mobility settings are negotiated between the source and target eNBs so that UE's handed over due to load balance will not be immediately handed over back. The procedure can either be followed or preceded by ordinary handovers, depending on the vendor implementation. A summary is shown in FIG. 5.

### Basic of Mobility Load Balancing (MLB) in NG RAN

MLB in NR follows signaling principles that are in line with LTE. Similar signaling mechanisms are used in NG-RAN with the difference that the MLB metrics are reported over the split RAN interfaces. To this end, signaling support for Resource Status Reporting has been introduced over Xn, F1 and E1, inter-node interfaces as well as enhanced over X2 for EN-DC scenario. In addition, the NG-RAN MLB functionality for has been enhanced by means of new types of load metrics and with finer load granularity compared to LTE (where load information is expressed on a per-cell basis only). In particular, it the NG-RAN MLB enhancements include:
Load information on a per Synchronization Signal Block (SSB) coverage area granularity, such as
   Radio Resource Status reporting per SSB area
   Composite Available Capacity reporting per SSB Area Load information on a per network slice granularity, such as
   Slice Available Capacity reporting per slice
Hardware load indicator over E1
TNL capacity indication
Number of active UEs
Number of RRC connections

As an example, one can consider the Xn interface specification in TS 38.423 v16.2.0, where Resource Status Reporting Indication procedure is specified in sections 8.4.10, 8.4.11 and 9.1.3.

### Load and Capacity Information

In the current standard information concerning per cell load and capacity are captured via the following information elements, which are here reported with respect to the NR RAT for convenience. The following is an excerpt of TS 38.423 v16.3.0.

9.2.2.50 Radio Resource Status

The Radio Resource Status IE indicates the usage of the PRBs per cell and per SSB area for all traffic in Downlink and Uplink and the usage of Physical Downlink Control Channel (PDCCH) control channel elements (CCEs) for Downlink and Uplink scheduling.

| | | | IE type and | Semantics |
|---|---|---|---|---|
| IE/Group Name | Presence | Range | reference | description |
| CHOICE Radio Resource | M | | | |
| Status Type | | | | |
| >ng-eNB | | | | |
| >>DL GBR PRB usage | M | | INTEGER (0..100) | Per cell DL GBR |
| | | | | PRB usage |
| >>UL GBR PRB usage | M | | INTEGER (0..100) | Per cell UL GBR |
| | | | | PRB usage |
| >>DL non-GBR PRB usage | M | | INTEGER (0..100) | Per cell DL non- |
| | | | | GBR PRB usage |
| >>UL non-GBR PRB usage | M | | INTEGER (0..100) | Per cell UL non- |
| | | | | GBR PRB usage |
| >>DL Total PRB usage | M | | INTEGER (0..100) | Per cell DL Total |
| | | | | PRB usage |
| >>UL Total PRB usage | M | | INTEGER (0..100) | Per cell UL Total |
| | | | | PRB usage |
| >gNB | | | | |
| >>SSB Area Radio Resource | | 1 | | |
| Status List | | | | |
| >>>SSB Area Radio | | 1..<maxnoofSSBAreas> | | |
| Resource Status Item | | | | |
| >>>>SSB Index | M | | INTEGER (0..63) | |
| >>>>SSB Area DL GBR PRB | M | | INTEGER (0..100) | Per SSB area DL |
| usage | | | | GBR PRB usage |
| >>>>SSB Area UL GBR PRB | M | | INTEGER (0..100) | Per SSB area UL |
| usage | | | | GBR PRB usage |
| >>>>SSB Area DL non-GBR | M | | INTEGER (0..100) | Per SSB area DL |
| PRB usage | | | | non-GBR PRB |
| | | | | usage |
| >>>>SSB Area UL non-GBR | M | | INTEGER (0..100) | Per SSB area UL |
| PRB usage | | | | non-GBR PRB |
| | | | | usage |
| >>>>SSB Area DL Total PRB | M | | INTEGER (0..100) | Per SSB area DL |
| usage | | | | Total PRB usage |
| >>>>SSB Area UL Total PRB | M | | INTEGER (0..100) | Per SSB area UL |
| usage | | | | Total PRB usage |
| >>DL scheduling PDCCH | O | | INTEGER (0..100) | |
| CCE usage | | | | |
| >>UL scheduling PDCCH | O | | INTEGER (0..100) | |
| CCE usage | | | | |

| Range bound | Explanation |
|---|---|
| maxnoofSSBAreas | Maximum no. SSB Areas that can be served by a NG- |
| | RAN node cell. Value is 64. |

### 9.2.2.51 Composite Available Capacity Group

The Composite Available Capacity Group IE indicates the overall available resource level per cell and per SSB area in the cell in Downlink and Uplink.

| | | | IE type | |
|---|---|---|---|---|
| | | | and | Semantics |
| IE/Group Name | Presence | Range | reference | description |
| Composite Available | M | | Composite | For the Downlink |
| Capacity Downlink | | | Available | |
| | | | Capacity | |
| | | | 9.2.2.52 | |
| Composite Available | M | | Composite | For the Uplink |
| Capacity Uplink | | | Available | |
| | | | Capacity | |
| | | | 9.2.2.52 | |

### 9.2.2.52 Composite Available Capacity

The Composite Available Capacity IE indicates the overall available resource level in the cell in either Downlink or Uplink.

| | | | IE type | |
|---|---|---|---|---|
| | | | and | |
| IE/Group Name | Presence | Range | reference | Semantics description |
| Cell Capacity Class | O | | 9.2.2.53 | |
| Value | | | | |
| Capacity Value | M | | 9.2.2.54 | ‘0’ indicates no resource is |
| | | | | available, Measured |
| | | | | on a linear scale. |

### 9.2.2.53 Cell Capacity Class Value

The Cell Capacity Class Value IE indicates the value that classifies the cell capacity with regards to the other cells. The Cell Capacity Class Value IE only indicates resources that are configured for traffic purposes.

| | | | IE type | |
|---|---|---|---|---|
| | | | and | |
| IE/Group Name | Presence | Range | reference | Semantics description |
| Capacity Class Value | M | | INTEGER | Value 1 indicates the minimum |
| | | | (1..100, . . . ) | cell capacity, and 100 indicates the |
| | | | | maximum cell capacity. There |
| | | | | should be a linear relation between |
| | | | | cell capacity and Cell Capacity |
| | | | | Class Value. |

### 9.2.2.54 Capacity Value

The Capacity Value IE indicates the amount of resources per cell and per SSB area that are available relative to the total NG-RAN resources. The capacity value should be measured and reported so that the minimum NG-RAN resource usage of existing services is reserved according to implementation. The Capacity Value IE can be weighted according to the ratio of cell capacity class values, if available.

| | | | IE type | |
|---|---|---|---|---|
| | | | and | |
| IE/Group Name | Presence | Range | reference | Semantics description |
| Capacity Value | M | | INTEGER | Value 0 indicates no available |
| | | | (0..100) | capacity, and 100 indicates |
| | | | | maximum available capacity with |
| | | | | respect to the whole cell. Capacity |
| | | | | Value should be measured on a |
| | | | | linear scale. |
| SSB Area Capacity | | 0..1 | | |
| Value List | | | | |
| >SSB Area Capacity | | 0..<maxnoofSSBAreas> | | |
| Value Item | | | | |
| >>SSB Index | M | | INTEGER | |
| | | | (0..63) | |
| >>SSB Area Capacity | M | | INTEGER | Value 0 indicates no available |
| Value | | | (0..100) | capacity, and 100 indicates |
| | | | | maximum available capacity. SSB |
| | | | | Area Capacity Value should be |
| | | | | measured on a linear scale. |

| Range bound | Explanation |
|---|---|
| maxnoofSSBAreas | Maximum no. SSB Areas that can be served by a NG- |
| | RAN node cell. Value is 64. |

From the above it can be seen that the Radio Resource Status constitutes a percentage measure of the PRBs that are used in a cell. This metric can be either expressed per cell, or per SSB Area. The metric can distinguish between per Guaranteed Bit Rate (GBR) and per non GBR bearers and it can express PDDCH resource utilization.

Similarly, the Composite Available Capacity is represented as a measure of available capacity (the Capacity Value Information Element (IE)) with respect to the Cell Capacity Class Value IE, which constitutes the maximum cell capacity available.

### SUMMARY

There currently exist certain challenge(s). For example, in unlicensed spectrum, the existing solutions for setting the ED threshold for users include both fixed settings as well as threshold adaptation. The optimal selection of the ED threshold is largely dependent on the deployment scenario (indoor, outdoor, etc.), the load situation, the existence of external uncontrolled interferer, and many other factors. The selection of ED by a device has a direct impact on the inter-cell interference and therefore, on the coexistence and achievable performance. An operator, controlling a certain set of cells within the same area can configure the ED threshold for each device in a centralized or distributed manner in order to improve the coexistence between those devices. However, in unlicensed spectrum, existence of other inter-/intra technology devices operating on the same unlicensed spectrum cannot be ruled out. Currently there is no means of communication to figure out the LBT parameters (such as ED threshold) used by a neighboring node and therefore the coexistence and sharing is always suboptimal.

Setting the ED threshold per node using a distributed algorithm without having any knowledge of the ED threshold of other nodes has a high risk of being trapped in local minima and suboptimal solution.

Aside from the absence of LBT configuration related information among neighboring nodes, some existing metric were defined only taking the licensed operation in mind, and cannot be directly reused for unlicensed operation. Otherwise, a correct interpretation of the exchanged information cannot be guaranteed. For instance, in the existing load balancing metrics, it is not possible to express the characteristics of the resources available and utilized in NR-U. Namely, in NR-U the time frequency resources corresponding to a channel, where a channel is typically spanning a 20 MHz frequency band, are not always available for communication between a UE and a RAN node. This is because the channel may become unavailable as a result of the LBT process, i.e. it may be occupied by other systems or devices.

Therefore, if load balancing mechanisms need to be used for NR-U, there would be a problem on how to reuse the currently standardized information. This information would in fact lead to the understanding that resources are always available and that they are either available or utilized. As an example of the problem that may occur, one can consider a RAN node cell where an NR-U channel is not usable due to LBT blockage, i.e. due to the fact that the energy level detected on the overall channel is above the threshold that determines if the channel can be used or not. In this case, and according to the current standard, the resources belonging to this channel may be marked as utilized. The latter is misleading as it lets the node receiving this information believe that these resources are used due to a load served by the RAN node sending the load balancing metrics. Instead the resources are not used and the RAN node sending the load balancing information is not serving the load that presumably occupies the resources. Indeed the RAN node's cell for which the load balancing information is sent may be very lowly loaded.

Likewise, if the resources that are unavailable due to failure of the LBT process were marked as available, this would also be misleading because that would let the RAN node receiving the load balancing information believe that there are unused resources in a potential target cell. This may trigger handovers towards that target cell, e.g. for load balancing purposes, while the resources presumably available there are not accessible due to persistent LBT failure.

In addition to that, the LBT configuration in a cell has an impact on the experienced load. For instance, a low ED threshold reduces the chances of accessing the medium and therefore might lead to high congestion quicker than a higher ED threshold. Therefore, it should be clear which LBT configuration is used when reporting certain load or channel information.

Certain aspects of the present disclosure and their embodiments may provide solutions to these or other challenges. There are, proposed herein, various embodiments which address one or more of the issues disclosed herein. The embodiments include, for example:
1) Exchange between RAN nodes of information concerning the way a shared channel is deemed available or occupied, for the purpose of understanding the shared channel conditions at neighbor cells when such shared resources are available and to optimize the selection of such parameters for channel occupancy evaluation.
2) Exchange between RAN nodes load information that take into account shared channel occupancy and factors concerning how resources are used when a channel is shared. The purpose here is to evaluate the amount of resources a neighbor node can access to and the load in terms of resources used out of those available. Also, the quality of the resources available can be determined by any neighbor node.
3) Combining load information for shared channels and parameters used for channel occupancy evaluation, received from neighbor RAN nodes, in order to determine the best combination between mobility policies and channel availability evaluation parameters, which allows for optimal shared resource efficiency.

In each embodiment, the RAN node may be any suitable RAN node, such as any of gNB, eNB, en-gNB, ng-eNB, gNB-CU, gNB-CU-CP, eNB-CU, eNB-CU-CP. In certain embodiments, the first and second embodiment described above may be combined to generate the third embodiment.

According to certain embodiments, a method performed by a first RAN node comprises receiving, from a second RAN node, load metrics associated with a shared channel and LBT configuration information. The LBT configuration information indicates how a determination is made whether the shared channel is occupied or available for communication between the second RAN node and a wireless device. The method further comprises performing one or more operations of the first RAN node based at least in part on the load metrics and the LBT configuration information received from the second RAN node.

According to certain embodiments, a first RAN node comprises power supply circuitry and processing circuitry. The power supply circuitry is configured to supply power to the first RAN node. The processing circuitry is configured to receive, from a second RAN node, load metrics associated with a shared channel and LBT configuration information. The LBT configuration information indicates how a determination is made whether the shared channel is occupied or available for communication between the second RAN node and a wireless device. The processing circuitry is further configured to perform one or more operations of the first RAN node based at least in part on the load metrics and the LBT configuration information received from the second RAN node.

Certain embodiments of the above-described first RAN node or the method performed by the first RAN node may include additional features, such as one or more of the following features:

In certain embodiments, the one or more operations comprise adapting an LBT configuration of the first RAN node.

In certain embodiments, the one or more operations comprise determining a load status of the second RAN node based on the load metrics and the LBT configuration information received from the second RAN node. In certain embodiments, the one or more operations further comprise performing load balancing with the second RAN node based on the load status determined for the second RAN node.

In certain embodiments, the one or more operations further comprise sending the second RAN node a request to change an LBT configuration of the second RAN node.

In certain embodiments, the load metrics and the LBT configuration information are received in response to sending the second RAN node a request to provide the load metrics and the LBT configuration information.

In certain embodiments, the load metrics associated with the shared channel include load metrics for communication on a downlink from the second RAN node to the wireless device.

In certain embodiments, the LBT configuration information indicates how the determination is made whether the shared channel is occupied or available for communication on the downlink.

In certain embodiments, the load metrics associated with the shared channel include load metrics for communication on an uplink from the wireless device to the second RAN node.

In certain embodiments, the LBT configuration information indicates how the determination is made whether the shared channel is occupied or available for communication on the uplink.

In certain embodiments, the LBT configuration information comprises a channel access configuration for the shared channel, the channel access configuration including an ED threshold configuration.

In certain embodiments, the shared channel uses unlicensed spectrum and is shared by the second RAN node and at least one other node. In certain embodiments, the at least one other node uses a different radio access technology than the second RAN node.

According to certain embodiments, a method performed by a second RAN node comprises determining load metrics associated with a shared channel and LBT configuration information. The LBT configuration information indicates how a determination is made whether the shared channel is occupied or available for communication between the second RAN node and a wireless device. The method further comprises sending the load metrics and the LBT configuration information to a first RAN node.

According to certain embodiments, a second RAN node comprises power supply circuitry and processing circuitry. The power supply circuitry is configured to supply power to the second RAN node. The processing circuitry is configured to determine load metrics associated with a shared channel and LBT configuration information. The LBT configuration information indicates how a determination is made whether the shared channel is occupied or available for communication between the second RAN node and a wireless device. The processing circuitry is further configured to send the load metrics and the LBT configuration information to a first RAN node.

Certain embodiments of the above-described second RAN node or the method performed by the second RAN node may include additional features, such as one or more of the following features:

Certain embodiments receive, from the first RAN node, a request to change an LBT configuration of the second RAN node and, in response to the request, change the LBT configuration of the second RAN node.

Certain embodiments send the load metrics and the LBT configuration information to the first RAN node in response to receiving, from the first RAN node, a request to provide the load metrics and the LBT configuration information.

In certain embodiments, the load metrics associated with the shared channel include load metrics for communication on a downlink from the second RAN node to the wireless device.

In certain embodiments, the LBT configuration information indicates how the determination is made whether the shared channel is occupied or available for communication on the downlink.

In certain embodiments, the load metrics associated with the shared channel include load metrics for communication on an uplink from the wireless device to the second RAN node.

In certain embodiments, the LBT configuration information indicates how the determination is made whether the shared channel is occupied or available for communication on the uplink.

In certain embodiments, the LBT configuration information comprises a channel access configuration for the shared channel, the channel access configuration including an ED threshold configuration.

In certain embodiments, the shared channel uses unlicensed spectrum and is shared by the second RAN node and at least one other node. In certain embodiments, the at least one other node uses a different radio access technology than the second RAN node.

According to certain embodiments, a computer program comprises instructions which when executed on a computer perform any of the steps of any of the above-described methods performed by a RAN node (e.g., the first RAN node or the second RAN node).

According to certain embodiments, a computer program product comprises a computer program, the computer program comprising instructions which when executed on a computer perform any of the steps of any of the above-described methods performed by a RAN node (e.g., the first RAN node or the second RAN node).

According to certain embodiments, a non-transitory computer-readable storage medium or carrier comprises a computer program, the computer program comprising instructions which when executed on a computer perform any of the steps of any of the above-described methods performed by a RAN node (e.g., the first RAN node or the second RAN node).

Certain embodiments may provide one or more of the following technical advantage(s). For example, certain embodiments allow for a coordinated deployment of NR-U cells where access to the shared spectrum is calculated in a harmonized way between NR-U RAN nodes and therefore where the performance of radio communication over the NR-U spectrum is optimized. The solution also provides techniques for accurate load information exchange when it comes to NR-U resources, by which a RAN node is aware of available and unavailable shares of resources, used and not used shares of resources and by which it is possible for a RAN node to coordinate the thresholds according to which channel is deemed as accessible, based on load recorded in neighbor cells.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of a 5G RAN (NG-RAN) architecture.

FIG. 2 illustrates an example of an FBE procedure depicting 3GPP semi-static channel occupancy [ETSI harmonized standard EN 301 893 Section 4.2.7.3.1].

FIG. 3 illustrates an example of an overloaded scenario triggering MLB procedures.

FIG. 4 illustrates an example of X2 Load exchange procedures for MLB.

FIG. 5 illustrates an example of MLB execution, including Mobility Parameter Change procedure.

FIG. 6 illustrates an example of a wireless network in accordance with some embodiments.

FIG. 7 illustrates an example of User Equipment in accordance with some embodiments.

FIG. 8 illustrates an example virtualization environment in accordance with some embodiments.

FIG. 9 illustrates an example telecommunication network connected via an intermediate network to a host computer in accordance with some embodiments.

FIG. 10 illustrates an example host computer communicating via a base station with a user equipment over a partially wireless connection in accordance with some embodiments.

FIG. 11 illustrates example methods implemented in a communication system including a host computer, a base station and a user equipment in accordance with some embodiments.

FIG. 12 illustrates example methods implemented in a communication system including a host computer, a base station and a user equipment in accordance with some embodiments.

FIG. 13 illustrates example methods implemented in a communication system including a host computer, a base station and a user equipment in accordance with some embodiments.

FIG. 14 illustrates example methods implemented in a communication system including a host computer, a base station and a user equipment in accordance with some embodiments.

FIG. 15 illustrates an example method in accordance with some embodiments.

FIG. 16 illustrates an example virtualization apparatus in accordance with some embodiments.

FIG. 17 illustrates an example method that may be performed by a network node in accordance with some embodiments.

FIG. 18 illustrates an example method that may be performed by a network node in accordance with some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Example Embodiments Using LBT Configuration Information and/or Load Metrics

In a first embodiment a first RAN node requests on a per cell basis to a second RAN node to report LBT configuration information for NR-U spectrum.
In a dependent embodiment the first RAN node may ask for LBT mode configuration (LBE or FBE, or even whether LBT mode is being used) on a per channel basis
In a dependent embodiment the first RAN node may ask for the NR-U channels in operation. Such request may either concern the channels that are in use at a specific point in time (e.g. at the time of receiving the request from the first RAN node), or it may concern the channels that have been in operation within a given time window before reception of the request from the first RAN node. The request from the first RAN node may convey the time window for calculation of the channels in operation or such time window may be previously configured at RAN nodes.
In a dependent embodiment the first RAN node may ask for per cell energy detection threshold information on a per channel basis
In a dependent embodiment the first RAN node may ask for per cell Received Signal Strength Indicator (RSSI) measurements on a per channel basis over an observation period.
   In a dependent embodiment, the first RAN node may ask for per beam (e.g., per synchronization signal block. SSB) per cell RSSI measurements on a per channel basis over an observation period. This per SSB level measurement would be relevant when the directional RSSI measurements can be performed.
In a dependent embodiment the first RAN node reports its own LBT configuration information on a per channel basis to the second node.
In a dependent embodiment, the first RAN node adapts the ED threshold it uses in its own cell(s), possibly per channel, in accordance with (i.e. to the same value as) the ED threshold reported by the second RAN node, wherein the ED threshold can be the ED threshold that the first/second RAN node uses for DL transmissions and/or the ED threshold the first/second RAN node configure to the UEs in their respective cells, i.e. for UL.
   In a further dependent embodiment, if the ED thresholds are configured differently in different beam directions (e.g., different SSB directions), then sub granularity of the measurement is at per beam directional level.
In a dependent embodiment, the first RAN node adapts the ED threshold configured for a certain UE, depending on the location of the UE, e.g. in accordance with the ED threshold reported by the second RAN node for UEs connected to the second RAN node and located in that location. This implies that the first network node may request the second network node to report the ED thresholds used for UEs in certain locations, and the second network node reporting the ED thresholds configured for UEs in those location.
In a dependent embodiment, the first RAN node may request the second RAN node to indicate the QoS of the UL/DL traffic currently handled, and hence the first RAN node may adapt the ED threshold on the basis of the QoS of the traffic handled by the second RAN node. For example, if the second RAN node is handling some DL traffic that is of higher priority than the traffic handled by the first RAN node, the first RAN node may configure a less aggressive ED threshold (i.e. lower ED threshold), whereas increase the ED threshold if the second RAN node is handling some lower priority traffic. Similarly, for the UL, depending on the priority of UL traffic of some UEs, and on the basis of their location, the first RAN node may adapt the ED threshold of the served UEs based on their location.

In a second embodiment, a first RAN node requests on a per cell basis to a second RAN node to change the LBT configuration for NR-U spectrum.
In a dependent embodiment the first RAN node may ask for adjusting the ED threshold used by the second RAN node on a per channel basis and for DL and/or UL transmissions. As a non-limiting example, the first node reports the ED threshold to be used by the second node, or reports an ED threshold offset from the currently used threshold. The first RAN node may also report its own ED threshold setting (i.e. the ED threshold it uses for the UEs communicating in its cell(s) and possibly also for itself (for the DL transmissions)) and ask the second RAN node to adjust its ED threshold accordingly (i.e. to the same ED threshold value).
In a dependent embodiment the first RAN node may ask for adjusting the ED threshold used by the second RAN node for its served UEs depending on the location of such UEs. For example, the first RAN node may indicate a set of coordinates so that the second RAN node will adjust the ED thresholds of UEs located in the surroundings of those coordinates.
In a dependent embodiment the first RAN node may ask for adjusting the ED threshold used by the second RAN node for UL/DL transmissions if/when the UL/DL traffic handled by the second RAN node is higher/lower than a certain QoS priority.
In a dependent embodiment, the request could also include the beams (in terms of SSBs) of the cells of second RAN node in which the change of LBT configuration for NR-U spectrum is requested.

In a third embodiment, a first RAN node requests on a per cell basis to a second RAN node to report Load metrics for NR-U spectrum.
In a dependent embodiment the first RAN node may ask for per cell load information on a per channel basis
   In a dependent embodiment, the request could be further granular in terms of beam directions i.e., per SSB per cell load information on a per channel basis.
In a dependent embodiment the first RAN node may specify the ED threshold for which the resources in the NR-U spectrum should be marked as available or not available, namely if the energy level perceived over the channel covering the resources analysed is above the threshold at a given point in time or during a given time duration, the resources are considered unavailable and if the energy level perceived over the channel covering the resources analyzed is below the threshold at a given point in time or during a given time duration, the resources are considered available

In this embodiment the second RAN node replies to the first RAN node with an acceptance or with a rejection of a report request or change request (in accordance of embodiment 1, 2, or 3) for cells using NR-U spectrum
In a dependent embodiment the second RAN node may fail the request from the first RAN node
In a dependent embodiment the second RAN node may partially accept the request, where such partial acceptance may concern specific cells and/or specific NR-U channels and/or it may be an acceptance for a specific reporting period

In this embodiment, upon acceptance from the second RAN node of the request to report LBT configuration metrics for NR-U, the second RAN node signals the requested information to the first RAN node
In a dependent embodiment, the second RAN node reports per cell and per NR-U channel, where for each channel any combination of the following is provided (all or subset):
   the energy detection threshold used to by the node to access the channel and obtain the resource availability information.
   For the case of FBE mode, the Fixed frame period and the start time of the FFP can be reported.
   the measured RSSI over an observation period
   the NR-U channels on which the cell is operating
   the ED threshold used in the UL, i.e. the energy detection threshold used by the devices communicating in the second RAN node's cell(s)
   LBT failure rate as an indication of how often the channel is found busy over an observation period
   Number of active UEs. as another variant, the second RAN node reports the number of UEs that are configured with grant-less transmission (i.e. may compete with the gNB's to access the channel)
   Information collected from Automatic Neighbor Relation (ANR) reports or similar reports from UEs about the presence of neighbor cells, gNBs, access points, networks
   Other non-limiting examples:
      Average/maximum channel occupancy time, i.e. when accessing the channel for how long the channel will be occupied on average/or maximum.
      number of devices with configured with autonomous (grant-less) transmissions within the cell.
      Indication of the priority classes being served, i.e. indication of the channel access priority based on the service type used by the gNB
      A prioritized list of NR-U channels which reflects the nodes preferred NR-U channels for operation. As a non-limiting example, the node lists the preferred NR-U channel for operation based on the RSSI measurements on the channels.

In this embodiment, upon acceptance from the second RAN node of the request to report load metrics for NR-U, the second RAN node signals NR-U resource capacity and resource utilization information to the first RAN node
In a dependent embodiment the second RAN node reports to the first RAN node resource availability information, per cell and per NR-U channel, where for each channel any combination of the following is provided:
   Interval of time during which the channel resources were unavailable due to LBT failure
   The percentage of time of the reporting interval during which the channel resources were unavailable due to LBT failure
   The probability of which the channel is detected to be available.
   Interval of time during which the channel resources were available and usable by the second RAN node
   Interval of time during which NR-U radio channel resources were available but not usable by the second RAN node due to non-radio related reasons. Examples may be due to backhaul bottlenecks or QoS flows parameters related constraints (e.g. ongoing PDU sessions of type ethernet)
   The amount of resources that were used by the second RAN node for the NR-U channel in question during the time interval when the channel resources were available. Such information about used resources may be expressed as a percentage with respect to the overall channel resources, or a number of resource blocks utilized
   The amount of resources that were requested for scheduling but that were not usable by the second RAN node for the NR-U channel in question during the time interval when the channel resources were unavailable. Such information about requested resources may be expressed as a percentage with respect to the overall channel resources, or a number of resource blocks requested.
   The available capacity at the cell and NR-U channel of the second RAN node for the NR-U channel in question during the time interval when the channel resources were available, measured with respect to a reference available capacity such as the total available capacity of the NR-U channel or the available capacity of the entire cell or an aggregated capacity (sum of the total available capacity of the NR-U channel and the available capacity of the entire cell). The available capacity may be measured as the capacity available if all services served by the second RAN node in the cell and channel in question were served with the minimum resources required to guarantee acceptable performance.
   The available capacity at the cell and NR-U channel of the second RAN node for the NR-U channel in question during the full measurement period for load metrics reporting. Namely, this capacity would be calculated during the whole load metric measurement period and would be based on considering time frequency resources unavailable due to LBT failure as well as the time frequency resources not accessible because already used by the second RAN node for traffic transmission as not part of the available capacity, This available capacity is measured with respect to a reference available capacity such as the total available capacity of the NR-U channel or the available capacity of the entire cell or an aggregated capacity (sum of the total available capacity of the NR-U channels within the cell). The available capacity may be measured as the capacity available if all services served by the second RAN node in the cell and channel in question were served with the minimum resources required to guarantee acceptable performance.
   The number of times across the last reporting interval during which the status of the channel resources has changed from being available to being unavailable (this can provide an indication of the dynamics of the NR-U channel occupancy)
   An average measure of the fraction (e.g. percentage) of a certain cell's resources (across all the channels used in the cell) that were occupied by other systems or devices (e.g. communication not related to the cell) during a certain latest period of time.
   The fraction of a certain latest period of time during which all the cell's or channel's resources that were not occupied by other systems or devices (i.e. resources that were available for the RAN node to allocate to uplink or downlink transmission in the cell (or on the channel) were occupied by communication in the cell (or channel)
   The fraction of a certain latest period of time during which all the cell's or channel's resources that were not occupied by other systems or devices (i.e. resources that were available for the RAN node to allocate to uplink or downlink transmission in the cell (or on the channel) were not sufficient to serve the offered load, i.e. when more resources would have been needed to sufficiently serve the involved devices communication needs
   An estimate of the load the RAN node would have served, e.g. during a certain latest time period, on in a certain cell if all of its resources had always been available for allocation to communication within the cell, e.g. if all the channels used in the cell had never been occupied by other systems or devices
   An estimate of the load the RAN node would have served, e.g. during a certain latest time period, on a certain channel if the channel had never been occupied by other systems or devices.
In a dependent embodiment the second RAN node reports to the first RAN node rapid changes in resource availability information, per cell and per NR-U channel. E.g. the second RAN node does not report available channel resources for NR-U every reporting period, but only when delta compared to previous passes a certain threshold. In a dependent embodiment, the first RAN node signals to the second RAN node, before triggering the request for load metrics for NR-U, an indication to change the LBT threshold for LBT success/failure on a per NR-U channel. This indication implies that the second RAN node would measure the energy level on NR-U channels and determine if a channel is available or unavailable depending on the threshold signaled by the first RAN node, per channel.
In a dependent embodiment the first RAN node signals to the second RAN node, before triggering the request for load metrics for NR-U, duty cycle periods to adopt when evaluating whether an NR-U channel is available or not available. The second RAN node uses such duty cycles to perform load measurements for NR-U channels, e.g. to calculate whether a channel is available or not.
In another dependent embodiment, the second RAN node does not hold the reporting, but two types of reporting can be used instead, one “full reporting” containing the information as requested by the first RAN node, and a second, more “compact reporting”. This can be the case, e.g. whenever the NR-U available channel resources for a given reporting period are the same or almost the same (within a certain range) compared to the available resources as reported with the latest “full reporting”.

In another embodiment, a new procedure is used by the first RAN node to request to the second RAN node NR-U resource related information and report NR-U specific resource updates. The reason for using such alternative can be to decouple legacy reporting for NR from the reporting for NR-U. As an example, if NR-U is deployed only to serve specific service(s), some focus on load balancing for unlicensed spectrum may be preferable, and the associated signaling content can potentially be more easily extended.

In this embodiment, upon acceptance from the second RAN node of the request to report load metrics/LBT metrics for NR.U, the second RAN node signals the requested NR-U information to the first RAN node
In a dependent embodiment the second RAN node signals such information on a periodic basis based on the period suggested by the first RAN node in the request sent to the second RAN node. The reporting period suggested by the first RAN node can be the same or different compared to the legacy reporting period indicated by the first RAN node for reporting of cell resources not NR-U related.
In a dependent embodiment the second RAN node signals such information on a periodic basis based on a period adopted by the second RAN node

In any of the above embodiments involving reporting of configuration (e.g. LBT configuration, ED threshold, used channels, PRB usage, bandwidth, etc.) or load metrics between RAN nodes, the reporting may be performed:
On request from one RAN node to the other
Periodically, according to configuration or as requested by a neighbor RAN node, i.e. the receiver of the reports
Triggered by events, where the events may be configured or requested by the receiver of the report
   Such events may include:
      Channel occupancy related events (e.g. when a certain fraction of a channel's or cell's resources are occupied by other systems or devices, either momentarily or as an average during a certain time period)
      Exceedance of an LBT rate threshold
         This may be divided per uplink and downlink
      Exceedance of a load threshold
      That the LBT rate goes below an LBT rate threshold
      That the load goes below a load threshold
      That the cell (or a channel) becomes overloaded (i.e. its available resources are not sufficient to serve the communication needs of the devices using the cell (or channel)
      That a reported configuration or metric or measure changes significantly since the last report (e.g. a change in the LBT configuration or channel configuration or a change of the channel occupancy rate or load exceeding a certain threshold size)

In a further embodiment a first RAN node requests of a neighbor RAN node both Load information concerning NR-U resources and the thresholds according to which the resources have been considered available/not available. The first RAN node may, upon receiving a response from the second RAN node containing load information and threshold information, derive the load status of the neighbor RAN node on the basis of the threshold(s) used by the neighbor RAN node. Namely, the neighbor RAN node may be highly loaded because a too high threshold has been selected (i.e. a threshold for which more power is detected over the shared channel). In turn, the resources available over the shared channel would be highly interfered and its usage would be inefficient, requiring more resources to serve traffic that could otherwise be served with less resources if the interference was lower. From this evaluation the first RAN node may deduce that a better threshold for determining availability of NR-U resources is a lower threshold. Likewise, the first RAN node may signal to the neighbor RAN node that it should adopt a lower threshold to increase resource utilization efficiency and thereby reduce load.

As part of this embodiment the first RAN node may also signal a gain factor, as calculated by the first RAN node, concerning the usage of a different threshold for determining the availability of NR-U resources. Such gain factor may be calculated via a standardized formula, or it might be specific for the RAN node.

In the above set of embodiments, at times the granularity of measurements is performed at per cell per channel level. It is to be noted that there could be further granular measurements in terms of per SSB per cell per channel level when the directional measurements can be performed at per SSB level.

Certain embodiments may be implemented in the context of a standard, such as 3GPP TS 38.423, TS 36.423, etc.

### Example Systems, Methods, and Apparatuses

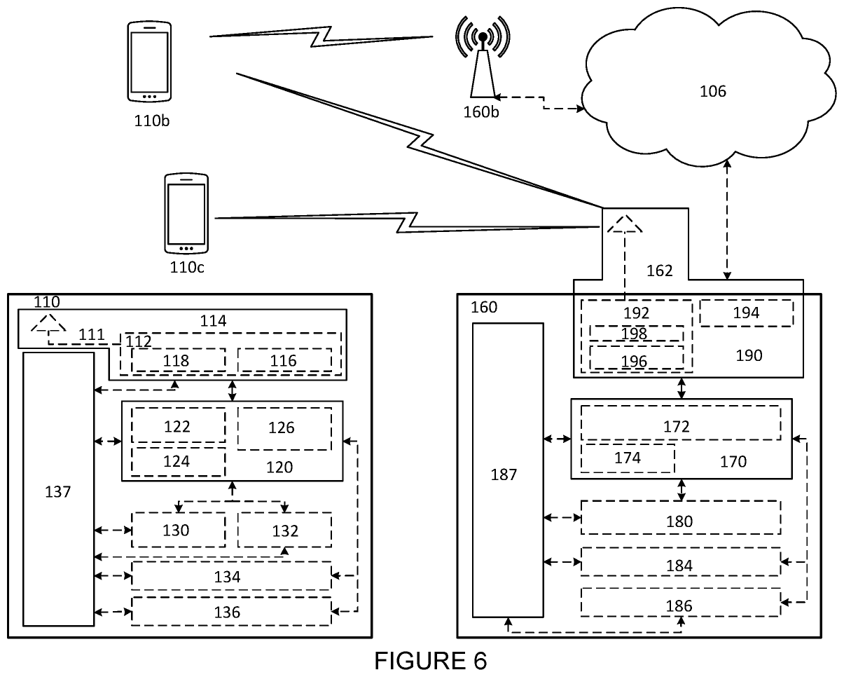

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., mobile switching centers (MSCs); mobility management entities (MMEs)), operation & maintenance (O&M) nodes, operation and support system (OSS) nodes, self-optimized network (SON) nodes, positioning nodes (e.g., evolved-Serving Mobile Location Centers, E-SMLCs), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 160 includes processing circuitry 170, device readable medium 180, interface 190, auxiliary equipment 184, power source 186, power circuitry 187, and antenna 162. Although network node 160 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, Wide Code Division Multiplexing Access WCDMA, LTE, NR. WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 6 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

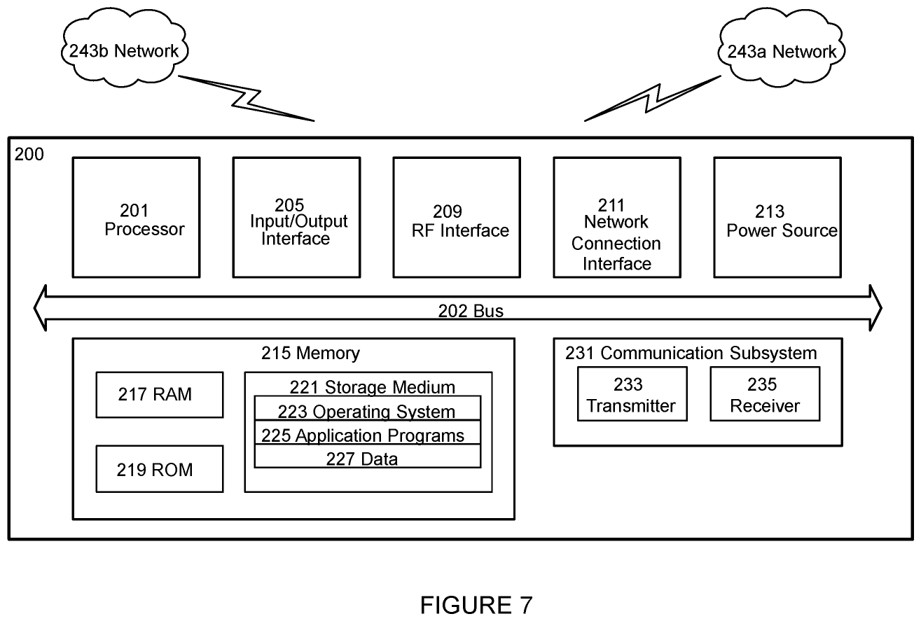

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 7, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, Universal Terrestrial Radio Access Network (UTRAN), WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

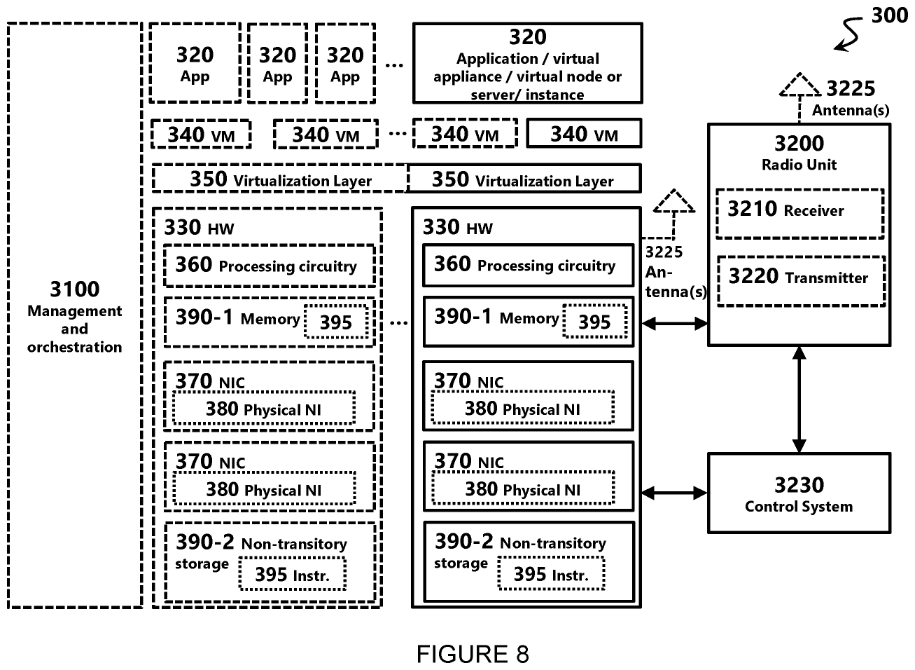

FIG. 8 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 8, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 8.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

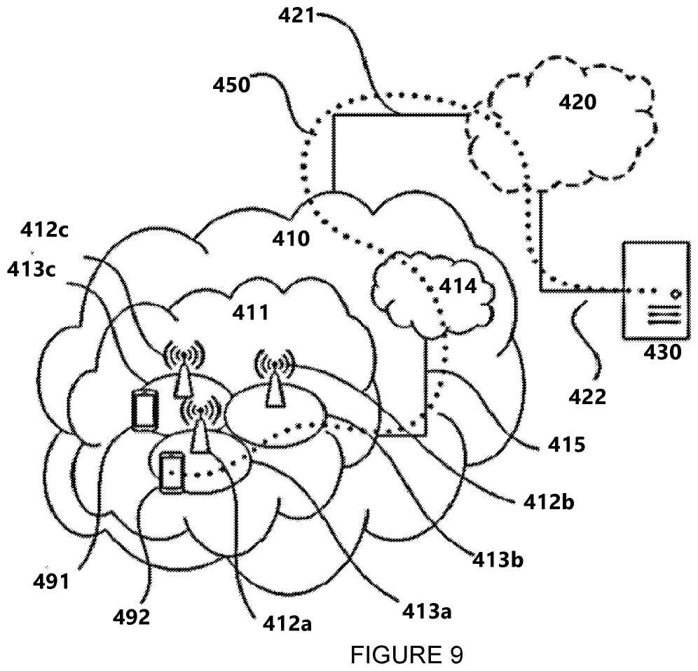

With reference to FIG. 9, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491. 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 9 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

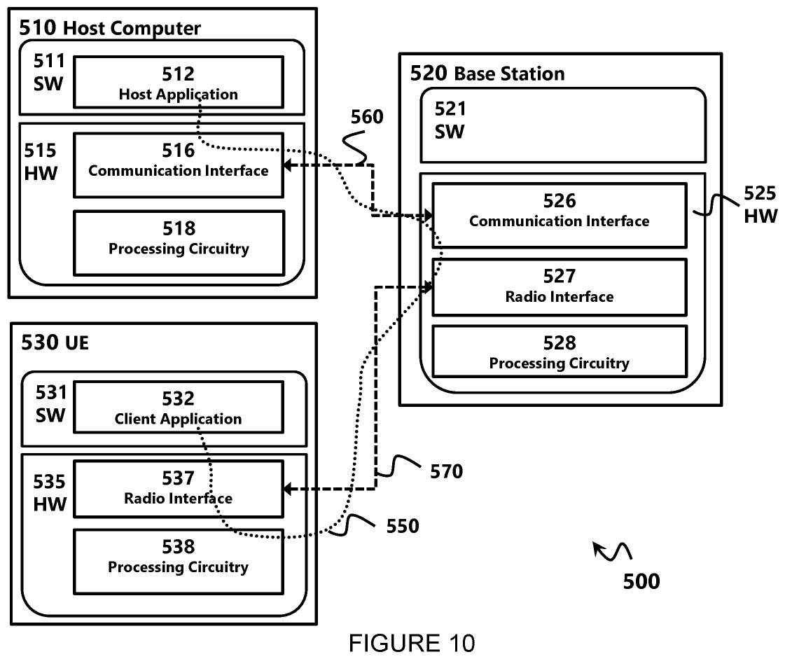

Example implementations, in accordance with an embodiment, of the UE, base station and host computer discussed in the preceding paragraphs will now be described with reference to FIG. 10. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 10) served by base station 520. Communication interface 526 may be configured to facilitate connection 560 to host computer 510. Connection 560 may be direct or it may pass through a core network (not shown in FIG. 10) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 10 may be similar or identical to host computer 430, one of base stations 412a, 412b, 412c and one of UEs 491, 492 of FIG. 9, respectively. This is to say, the inner workings of these entities may be as shown in FIG. 10 and independently, the surrounding network topology may be that of FIG. 9.

In FIG. 10, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the latency and/or data rate and thereby provide benefits such as reduced user waiting time and better responsiveness.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

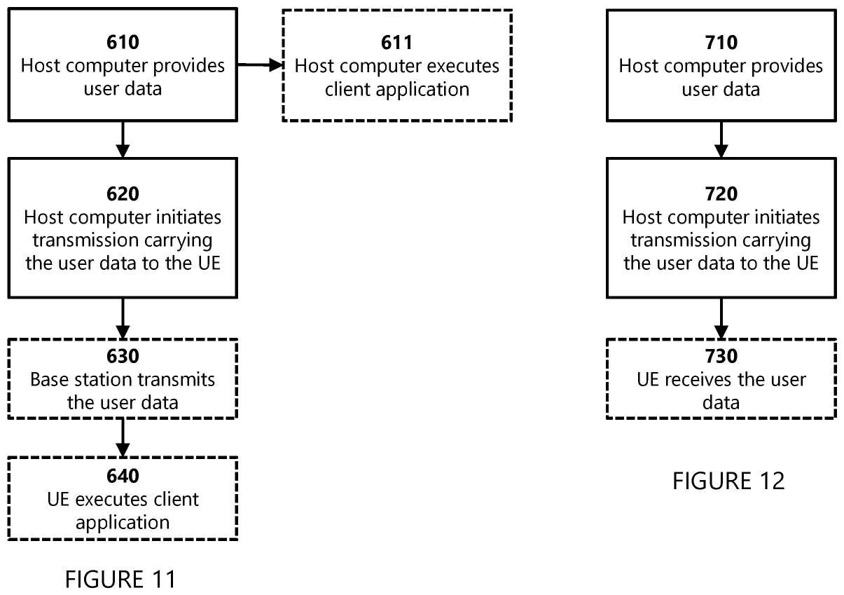

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

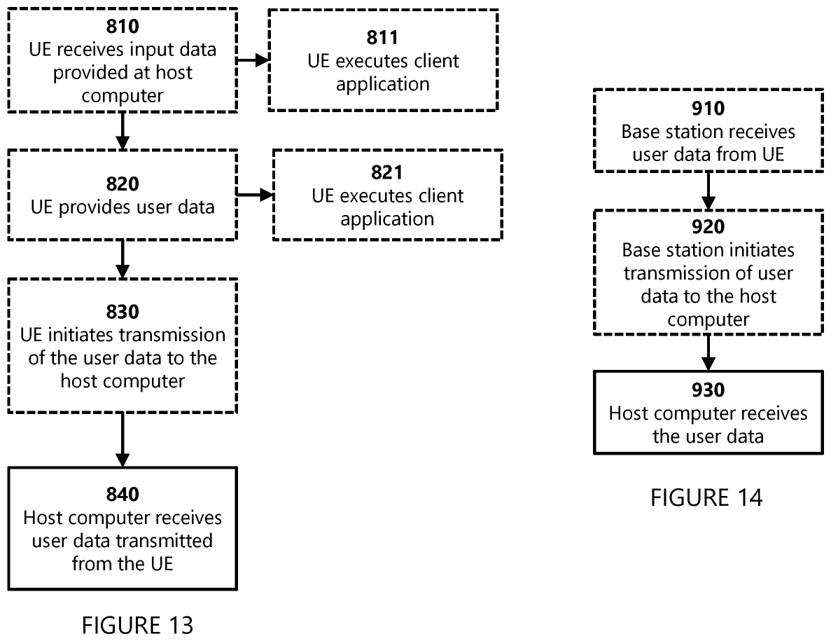

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

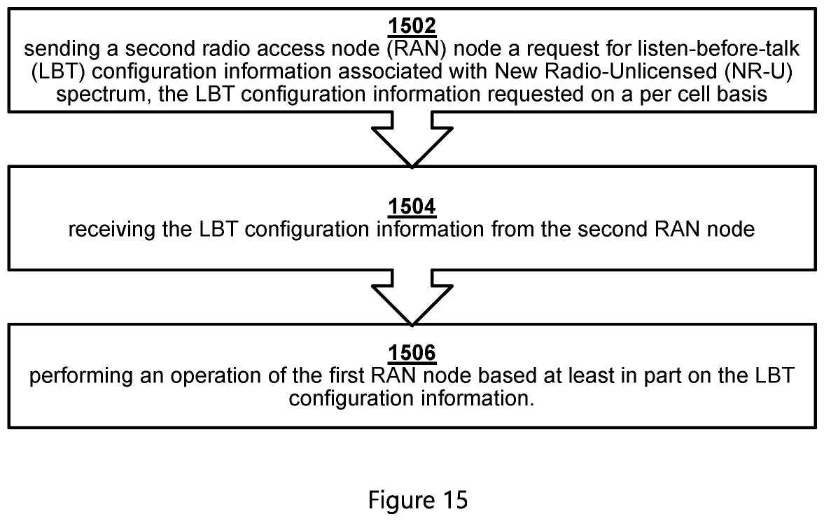

FIG. 15 depicts a method in accordance with particular embodiments. In certain embodiments, the method may be performed by a first RAN node, such as network node 160 described above. Examples of a RAN node may include gNB, eNB, en-gNB, ng-eNB, gNB-CU, gNB-CU-CP, eNB-CU, eNB-CU-CP, etc. The method begins at step 1502 with sending a second RAN node a request (on a per cell basis) for LBT configuration information associated with NR-U spectrum. The method proceeds to step 1504 with receiving the LBT configuration information from the second RAN node. The method continues to step 1506 with performing an operation of the first RAN node based at least in part on the LBT configuration information.

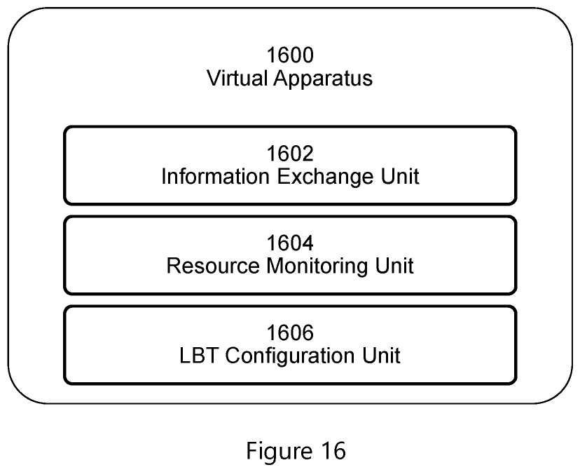

FIG. 16 illustrates a schematic block diagram of an apparatus 1600 in a wireless network (for example, the wireless network shown in FIG. 6). The apparatus may be implemented in a network node (e.g., network node 160 shown in FIG. 6). Apparatus 1600 is operable to carry out the example method described with reference to FIG. 15 and possibly any other processes or methods disclosed herein. It is also to be understood that the method of FIG. 15 is not necessarily carried out solely by apparatus 1600. At least some operations of the method can be performed by one or more other entities.

Virtual Apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause information exchange unit 1602, resource monitoring unit 1604, LBT configuration unit 1606, and any other suitable units of apparatus 1600 to perform corresponding functions according one or more embodiments of the present disclosure.

As illustrated in FIG. 16, apparatus 1600 includes information exchange unit 1602, resource monitoring unit 1604, and LBT configuration unit 1606. Information exchange unit 1602 is configured to exchange information with another network node. Examples of information that may be exchanged include requests to provide LBT configuration information or load information associated with NR-U spectrum, requests to change an LBT configuration, responses to such requests, and so on. Resource monitoring unit 1604 is configured to monitor one or more resources associated with a channel shared with the other network node. If resource monitoring unit 1604 determines, for example, that resource utilisation fails to meet certain criteria, resource monitoring unit 1604 may prompt information exchange unit 1602 to exchange information with another network node, for example, in order to facilitate changing an LBT configuration of the network node or an LBT configuration of the other network node. Changing the LBT configuration of one or both nodes may improve the resource utilisation observed by resource monitoring unit 1604. LBT configuration unit 1606 is configured to determine an LBT configuration for the network node and to apply the LBT configuration.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

### EMBODIMENTS

### Group A Embodiments

1. A method performed by a wireless device, the method comprising:
Receiving listen-before-talk (LBT) configuration information from a radio access network (RAN) node, the LBT configuration determined according to any of the Group B embodiments; and
Communicating with the RAN node according to the LBT configuration information.

2. The method of any of the previous embodiments, further comprising:
providing user data; and
forwarding the user data to a host computer via the transmission to the base station.

### Group B Embodiments

3. A method performed by a first radio access network (RAN) node, the method comprising:
Sending a second RAN node a request for listen-before-talk (LBT) configuration information;
Receiving the LBT configuration information from the second RAN node; and
Performing an operation of the first RAN node based at least in part on the LBT configuration information.

4. The method of embodiment 3, wherein the LBT configuration information is requested on a per cell basis.

5. The method of any of embodiments 3-4, wherein the LBT configuration information requests information for New Radio-Unlicensed (NR-U) spectrum.

6. The method of any of embodiments 3-5, wherein the operation comprises adapting an LBT configuration of the first RAN node based on the LBT configuration information received from the second RAN node.

7. A method performed by a first radio access network (RAN) node, the method comprising:
Sending a second RAN node a request to change a listen-before-talk (LBT) configuration of the second RAN node.

8. The method of embodiment 7, wherein the change is requested on a per cell basis.

9. The method of any of embodiments 7-8, wherein the change is requested for New Radio-Unlicensed (NR-U) spectrum.

10. The method of any of embodiments 7-9, wherein sending the request is in response to monitoring one or more resources associated with a channel shared with the second RAN node.

11. A method performed by a first radio access network (RAN) node, the method comprising:
Sending a second RAN node a to report load metrics;
Receiving the load metrics from the second RAN node; and
Performing an operation of the first RAN node based at least in part on the load metrics.

12. The method of embodiment 11, wherein the load metrics are requested on a per cell basis.

13. The method of any of embodiments 11-12, wherein the load metrics are requested for New Radio-Unlicensed (NR-U) spectrum.

14. The method of any of embodiments 11-13, wherein the operation comprises adapting an LBT configuration of the first RAN node based on the load metrics received from the second RAN node.

15. The method of any of embodiments 11-14, wherein the operation comprises sending the second RAN node a request to change an LBT configuration of the second RAN node based on the load metrics.

16. A method performed by a second radio access network (RAN) node, the method comprising
Receiving a request to provide listen-before-talk (LBT) configuration information to a first RAN node; and
Sending the LBT configuration information to the first RAN node.

17. The method of embodiment 16, wherein the LBT configuration information is requested on a per cell basis.

18. The method of any of embodiments 17-18, wherein the LBT configuration information requests information for New Radio-Unlicensed (NR-U) spectrum.

19. A method performed by a second radio access network (RAN) node, the method comprising
Receiving a request to change a listen-before-talk (LBT) configuration from a first RAN node; and
Changing the LBT configuration of the second RAN node.

20. The method of embodiment 19, wherein the change is requested on a per cell basis.

21. The method of any of embodiments 19-20, wherein the change is requested for New Radio-Unlicensed (NR-U) spectrum.

22. A method performed by a second radio access network (RAN) node, the method comprising
Receiving request to report load metrics to a first RAN node;
Determining the load metrics; and
Reporting the load metrics to the first RAN node.

23. The method of embodiment 22, wherein the load metrics are requested on a per cell basis.

24. The method of any of embodiments 22-23, wherein the load metrics are requested for New Radio-Unlicensed (NR-U) spectrum.

25. The method of any of embodiments 3-24, further comprising any of the embodiments described above under the heading “ADDITIONAL EXPLANATION.”

26. The method of any of the previous embodiments, further comprising:
obtaining user data; and
forwarding the user data to a host computer or a wireless device.

### Group C Embodiments

27. A wireless device, the wireless device comprising:
processing circuitry configured to perform any of the steps of any of the Group A embodiments; and
power supply circuitry configured to supply power to the wireless device.

28. A base station, the base station comprising:
processing circuitry configured to perform any of the steps of any of the Group B embodiments;
power supply circuitry configured to supply power to the base station.

29. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

30. A computer program, the computer program comprising instructions which when executed on a computer perform any of the steps of any of the Group A embodiments.

31. A computer program product comprising a computer program, the computer program comprising instructions which when executed on a computer perform any of the steps of any of the Group A embodiments.

32. A non-transitory computer-readable storage medium or carrier comprising a computer program, the computer program comprising instructions which when executed on a computer perform any of the steps of any of the Group A embodiments.

33. A computer program, the computer program comprising instructions which when executed on a computer perform any of the steps of any of the Group B embodiments.

34. A computer program product comprising a computer program, the computer program comprising instructions which when executed on a computer perform any of the steps of any of the Group B embodiments.

35. A non-transitory computer-readable storage medium or carrier comprising a computer program, the computer program comprising instructions which when executed on a computer perform any of the steps of any of the Group B embodiments.

36. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

37. The communication system of the pervious embodiment further including the base station.

38. The communication system of the previous 2 embodiments, further including the UE, wherein the UE is configured to communicate with the base station.

39. The communication system of the previous 3 embodiments, wherein:
the processing circuitry of the host computer is configured to execute a host application, thereby providing the user data; and
the UE comprises processing circuitry configured to execute a client application associated with the host application.

40. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

41. The method of the previous embodiment, further comprising, at the base station, transmitting the user data.

42. The method of the previous 2 embodiments, wherein the user data is provided at the host computer by executing a host application, the method further comprising, at the UE, executing a client application associated with the host application.

43. A user equipment (UE) configured to communicate with a base station, the UE comprising a radio interface and processing circuitry configured to performs the of the previous 3 embodiments.

44. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

45. The communication system of the previous embodiment, wherein the cellular network further includes a base station configured to communicate with the UE.

46. The communication system of the previous 2 embodiments, wherein:
the processing circuitry of the host computer is configured to execute a host application, thereby providing the user data; and
the UE's processing circuitry is configured to execute a client application associated with the host application.

47. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

48. The method of the previous embodiment, further comprising at the UE, receiving the user data from the base station.

49. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

50. The communication system of the previous embodiment, further including the UE.

51. The communication system of the previous 2 embodiments, further including the base station, wherein the base station comprises a radio interface configured to communicate with the UE and a communication interface configured to forward to the host computer the user data carried by a transmission from the UE to the base station.

52. The communication system of the previous 3 embodiments, wherein:
the processing circuitry of the host computer is configured to execute a host application; and
the UE's processing circuitry is configured to execute a client application associated with the host application, thereby providing the user data.

53. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

54. A method implemented in a communication system including a host computer, a base station and a user equipment (UE), the method comprising:
at the host computer, receiving user data transmitted to the base station from the UE, wherein the UE performs any of the steps of any of the Group A embodiments.

55. The method of the previous embodiment, further comprising, at the UE, providing the user data to the base station.

56. The method of the previous 2 embodiments, further comprising:
at the UE, executing a client application, thereby providing the user data to be transmitted; and
at the host computer, executing a host application associated with the client application.

57. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

58. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

59. The communication system of the previous embodiment further including the base station.

60. The communication system of the previous 2 embodiments, further including the UE, wherein the UE is configured to communicate with the base station.

61. The communication system of the previous 3 embodiments, wherein:
the processing circuitry of the host computer is configured to execute a host application;
the UE is configured to execute a client application associated with the host application, thereby providing the user data to be received by the host computer.

62. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

63. The method of the previous embodiment, further comprising at the base station, receiving the user data from the UE.

64. The method of the previous 2 embodiments, further comprising at the base station, initiating a transmission of the received user data to the host computer.

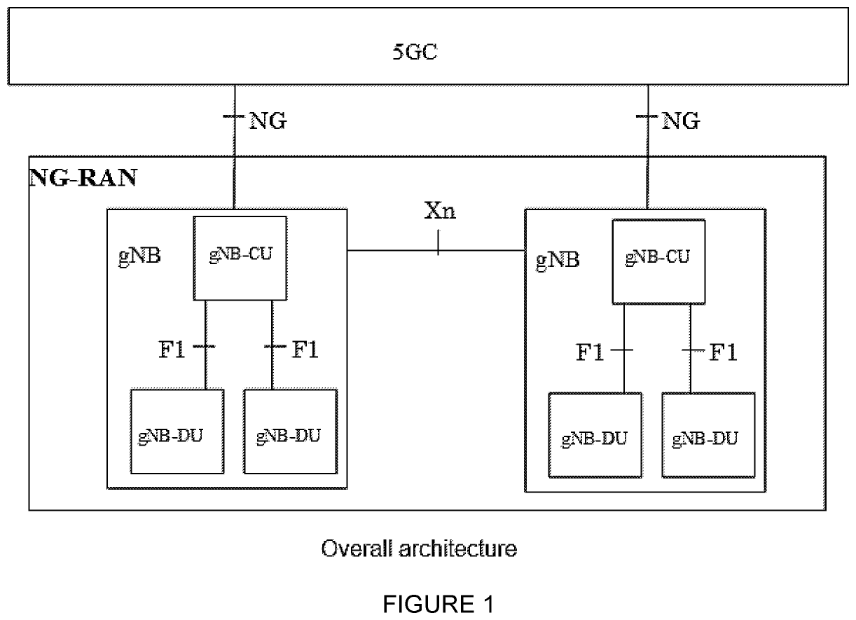

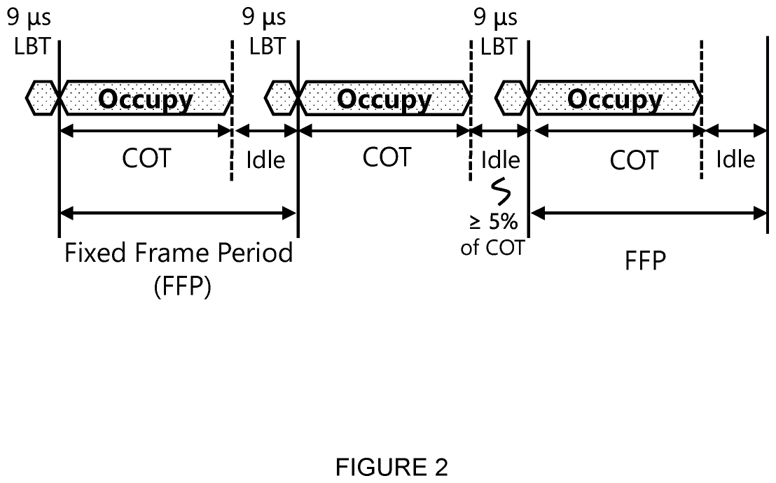

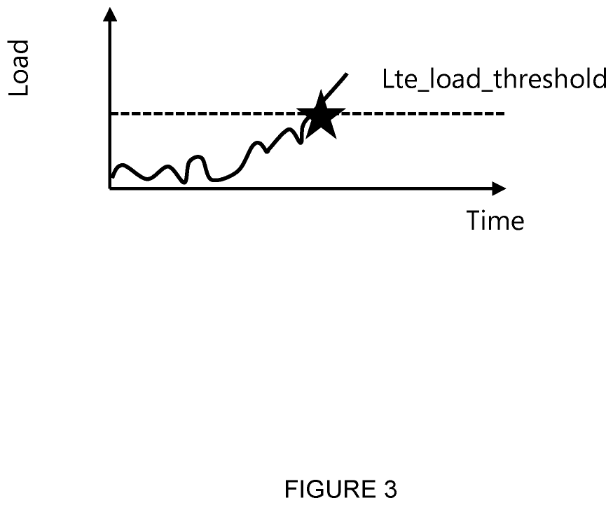

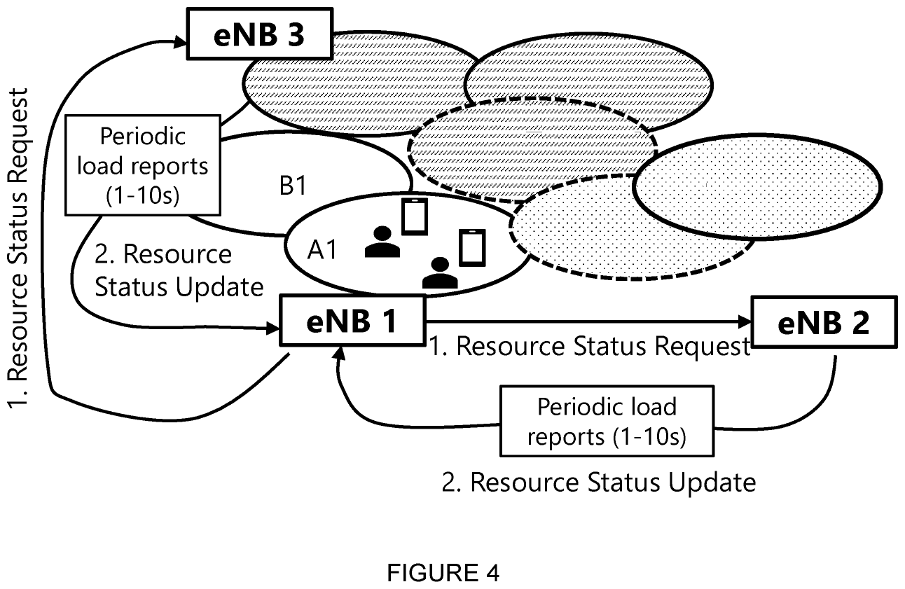

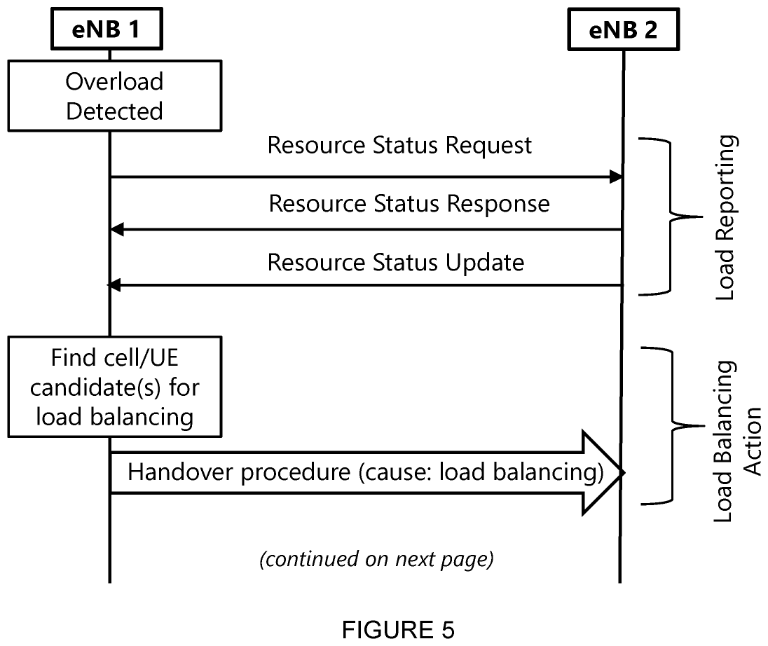

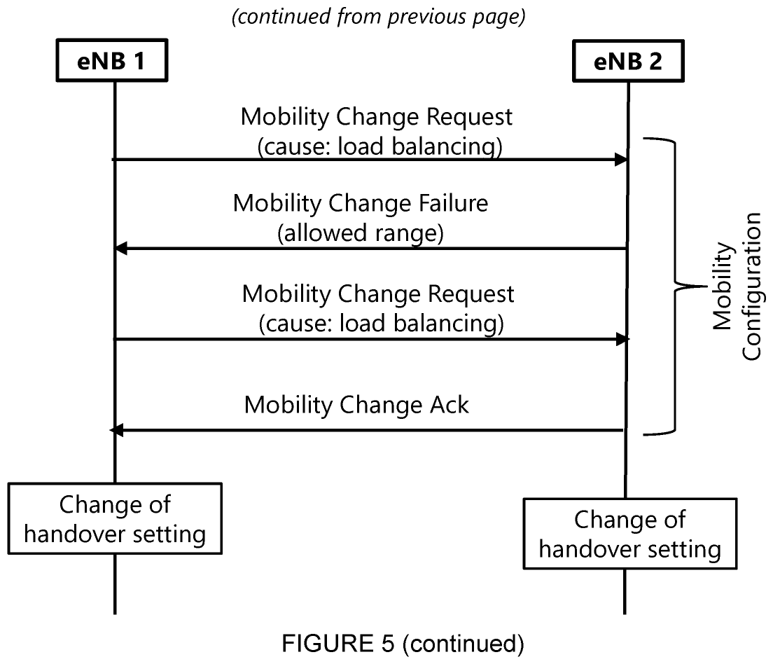

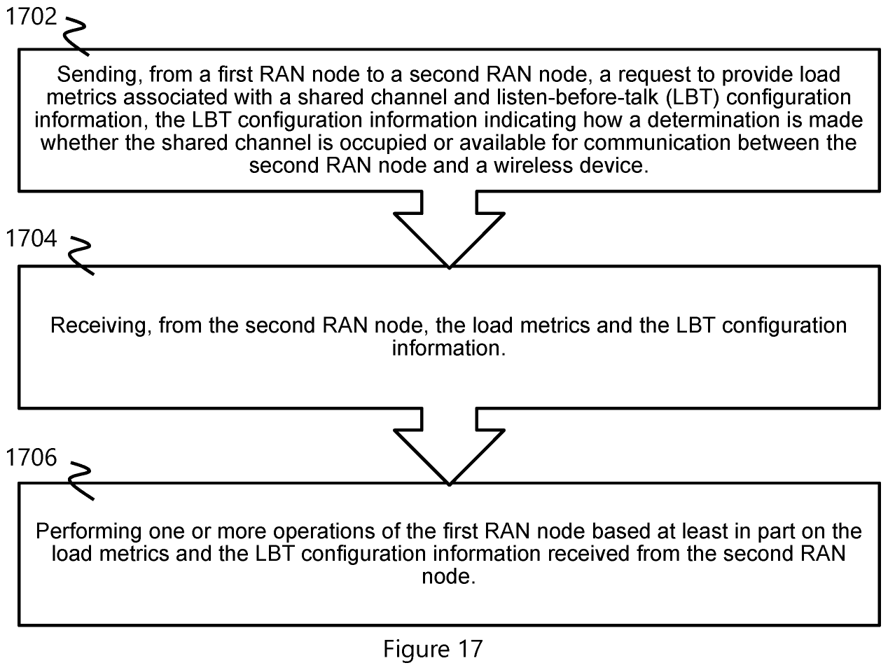

FIG. 17 illustrates an example of a method that may be performed by a network node, such as network node 160 described with respect to FIG. 6. For example, the network node may comprises processing circuitry 170 configured to perform the steps of the method. In certain embodiments, the network node may be a first RAN node. As examples, a gNB illustrated in FIG. 1, the eNB1 of FIG. 4, or the eNB1 of FIG. 5 may be configured to perform the method of FIG. 17.

In general, the method of FIG. 17 may enable the first RAN node to obtain information about a shared channel that a second RAN node uses to communicate with a wireless device. The shared channel may be shared by the second RAN node and at least one other node. In certain embodiments, the at least one other node uses a different radio access technology than the second RAN node. As an example, the second RAN node may use an NR radio access technology and the other node may use a WiFi radio access technology. In addition, or in the alternative, the shared channel may be shared with a node that uses the same radio access technology as the second RAN node. In an embodiment, the shared channel may be shared at least by the first RAN node and the second RAN node (and optionally by other nodes). In certain embodiments, the first RAN node and the second RAN node belong to the same RAN. In certain embodiments, the shared channel uses unlicensed spectrum.

In certain embodiments, the method of FIG. 17 begins at step 1702 with sending a request from the first RAN node to the second RAN node. The first RAN node requests the second RAN node to provide load metrics associated with the shared channel and LBT configuration information. Examples of load metrics may include a number of LBT processes that returned an indication that the shared channel was available/free, a percentage of time for which the shared channel resources were utilized for traffic served by the second RAN node (or by a particular cell of the second RAN node), a number of LBT processes that returned an indication that the shared channel was occupied, or other suitable metrics associated with a load of the shared channel. In certain embodiments, the load metrics associated with the shared channel include load metrics for communication on a downlink from the second RAN node to the wireless device, load metrics for communication on an uplink from the wireless device to the second RAN node, or both.

The LBT configuration information indicates how a determination is made whether the shared channel is occupied or available for communication between the second RAN node and a wireless device. In certain embodiments, the LBT configuration information indicates how the determination is made whether the shared channel is occupied or available for communication on the downlink, how the determination is made whether the shared channel is occupied or available for communication on the uplink, or both. For example, with respect to the uplink, the LBT configuration information may include LBT configuration information configured for the wireless device. The second RAN node may obtain the wireless device's LBT configuration information and may provide the wireless device's LBT configuration information to the first RAN node. For example, the second RAN node may obtain the wireless device's LBT configuration information based on an LBT configuration that the second RAN node requests the wireless node to use or based on the wireless device informing the second RAN node of the wireless device's LBT configuration information.

In certain embodiments, the LBT configuration information comprises a channel access configuration for the shared channel. The channel access configuration may include an ED threshold configuration (e.g., a threshold configuration for which the shared channel may be considered occupied if a detected energy level is above the ED threshold and the shared channel may be considered available if the detected energy level is below the ED threshold). As other examples, the channel access configuration information may include an LBT backoff time (e.g., a minimum time between LBT processes), an LBT sensing duration (e.g., a time during which channel sensing is carried out), and/or one or more other channel access configuration parameters. Channel access configuration parameters (e.g., ED threshold, LBT backoff time, LBT sensing duration, etc.) may be configured for the downlink, the uplink, or both.

Further examples of LBT configuration information and load metrics are described above, for example, under the heading “Example embodiments using LBT configuration information and/or load metrics.”

The method proceeds to step 1704 with receiving, from the second RAN node, the load metrics and the LBT configuration information and then to step 1706 with performing one or more operations of the first RAN node based at least in part on the load metrics and the LBT configuration information received from the second RAN node in step 1704.

As an example, the one or more operations in step 1706 may comprise sending the second RAN node a request to change an LBT configuration of the second RAN node. The LBT configuration may be changed for the downlink, the uplink (e.g., the second RAN node may communicate the LBT configuration change to the wireless device), or both.

As another example, the one or more operations performed in step 1706 may include determining a load status of the second RAN node based on the load metrics and the LBT configuration information received from the second RAN node. Additionally, in certain embodiments, the one or more operations further comprise performing load balancing with the second RAN node based on the load status determined for the second RAN node. That is, the first RAN node may use the load metrics and LBT configuration information received in step 1704 to determine an appropriate picture of the load situation in the second RAN node and to facilitate load balancing between the first RAN node and the second RAN node. For example, the first RAN node may make load-balancing decisions based on the load metrics of the second RAN node. The load balancing decisions may include offloading a portion of the load from the first RAN node to the second RAN node. As an example, suppose the load metrics for the previous reporting period indicate that the second RAN node transferred 1X amount of traffic. Further suppose that the first RAN node determines that the second RAN node has a capacity to handle 2X amount of traffic. The first RAN node may predict that the second RAN node has capacity to handle more traffic in the next period (e.g., the first RAN node may predict based on the previous reporting period that the second node will likely receive approximately 1× amount of traffic in the next period and therefore can handle another approximately 1× amount of traffic based on load balancing in order to reach its capacity of 2×). In addition, the LBT configuration information received from the second RAN node may help the first RAN node understand how the second RAN node determines its load. In certain embodiments, the first RAN node instructs the second RAN node to modify the second RAN node's LBT configuration (e.g., the LBT configuration used on the downlink, the uplink, or both) so that the shared channel becomes more available to the second RAN node. This may increase the capacity of the second RAN node and may in turn allow more traffic to be offloaded to the second RAN node as part of load balancing.

As another example, in certain embodiments, the one or more operations performed in step 1706 include adjusting an LBT configuration of the first RAN node. For example, the information obtained in step 1704 may enable the first RAN node to understand how quickly the shared channel will be occupied. The first RAN node may adapt its own LBT configuration based on the LBT configuration of its neighbor (e.g., the second RAN node). Certain embodiments may use the same LBT configuration as the neighbor (e.g., for fairness). Other embodiments may use a different LBT configuration than the neighbor, for example, to find a good co-existence and optimize the network as a whole. Thus, in certain embodiments, the one or more operations performed by the first RAN node facilitate sharing the shared channel in a fair manner. Rather than hard-coding an LBT configuration for all nodes in the RAN, decisions can be made based on the conditions experienced by a particular node/cell and its neighbors. For example, if a Wifi node is preventing the first RAN node and the second RAN node from getting sufficient access to the shared channel, the first RAN node may determine to adapt its LBT configuration and/or to instruct the second RAN node to adapt the second RAN node's LBT configuration. The first RAN node may consider trade-offs in order to determine optimized LBT configuration settings. For example, the first RAN node may determine that it would be more fair to adapt the LBT configuration(s) in order to increase the availability of the shared channel for the first RAN node and/or the second RAN node, and the first RAN node may take into consideration a trade-off that interference may increase.

In certain embodiments, one or more steps of FIG. 17 may be performed on a per cell basis. For example, the LBT configuration information and/or load metrics may be requested and received on a per cell basis. As another example, the first RAN node may request the second RAN node to change an LBT configuration on a per cell basis. In this manner, the LBT configuration may be adapted based on factors specific to the cell. For example, a cell that typically experiences low availability of the shared channel may be instructed to decrease its ED threshold in order to improve the likelihood of the cell gaining access to the shared channel, whereas a cell that typically experiences high availability of the shared channel may not need to decrease its ED threshold.

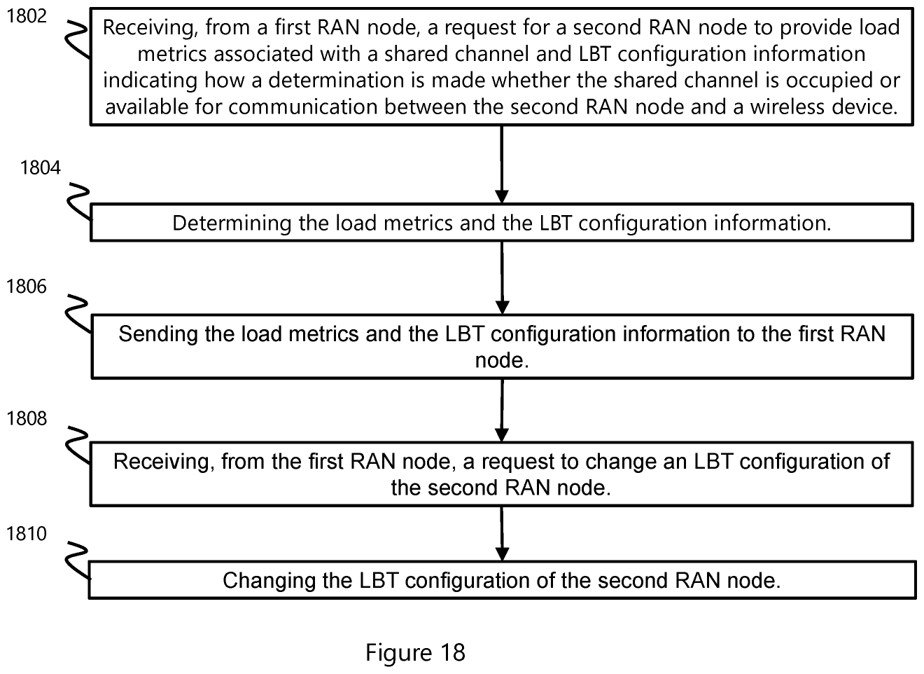

FIG. 18 illustrates an example of a method that may be performed by a network node, such as network node 160 described with respect to FIG. 6. For example, the network node may comprises processing circuitry 170 configured to perform the steps of the method. In certain embodiments, the network node may be a second RAN node. As examples, a gNB illustrated in FIG. 1, the eNB2 or eNB3 of FIG. 4, or the eNB2 of FIG. 5 may be configured to perform the method of FIG. 18. In some embodiments, certain aspects of the methods of FIG. 17 and FIG. 18 may generally be reciprocal. For example, FIG. 17 may describe sending certain information from the first RAN node to the second RAN node, and FIG. 18 may describe receiving the information at the second RAN node.

The method begins at step 1802 with receiving, from a first RAN node, a request for a second RAN node to provide load metrics associated with a shared channel and to provide LBT configuration information. The LBT configuration information indicates how a determination is made whether the shared channel is occupied or available for communication between the second RAN node and a wireless device. Examples of a shared channel, load metrics, and LBT configuration information are described above, for example, with respect to FIG. 17. In certain embodiments, load metrics may include a number of LBT processes that returned an indication that the shared channel was available/free, a percentage of time for which the shared channel resources were utilized for traffic served by the second RAN node (or by a particular cell of the second RAN node), a number of LBT processes that returned an indication that the shared channel was occupied, or other suitable metrics associated with a load of the shared channel. In certain embodiments, the LBT configuration information comprises a channel access configuration for the shared channel. The channel access configuration may include an ED threshold configuration, an LBT backoff time, an LBT sensing duration, and/or one or more other channel access configuration parameters.

Further examples of LBT configuration information and load metrics are described above, for example, under the heading “Example embodiments using LBT configuration information and/or load metrics.”

The method proceeds to step 1804 with determining the load metrics and the LBT configuration information and then to step 1806 with sending the load metrics and the LBT configuration information to a first RAN node. In certain embodiments, the load metrics associated with the shared channel may include load metrics for communication on a downlink from the second RAN node to the wireless device, load metrics for communication on an uplink from the wireless device to the second RAN node, or both. Certain load metrics may be measured by the second RAN node (such as downlink load metrics). Other load metrics may be obtained from the wireless device (such as uplink load metrics). The LBT configuration information may indicate how the determination is made whether the shared channel is occupied or available for communication on the downlink, how the determination is made whether the shared channel is occupied or available for communication on the uplink, or both. With respect to the uplink, the LBT configuration information may include LBT configuration information configured for the wireless device. The second RAN node may obtain the LBT configuration information for the uplink based on an LBT configuration that the second RAN node requests the wireless node to use or based on the wireless device informing the second RAN node of the wireless device's LBT configuration information.

As described above with respect to FIG. 17, step 1706, the first RAN node may perform one or more operations based on the load metrics and the LBT configuration information. In some embodiments, the one or more operations include requesting the second RAN node to change its LBT configuration. Thus, certain embodiments of FIG. 18 further comprise the steps of receiving, from the first RAN node, a request to change an LBT configuration of the second RAN node (step 1808) and changing the LBT configuration of the second RAN node in response to the request (step 1810).

Certain embodiments may perform one or more of the steps of FIG. 18 per cell. For example, load metrics and/or LBT configuration information may be requested, determined, and/or provided per cell. Changes to LBT configuration may be requested and/or performed per cell.

Certain embodiments of the present disclosure may be implemented in the context of a standard. The following provides an example of including certain features in a 3GPP standard, in accordance with some embodiments of the present disclosure.

### INTRODUCTION

The WI on Enhancement of Data Collection for SON/MDT in NR includes the topic of “10.5. SON/MDT Optimizations for NR-U”.
The topic of NR-U is described as follows in the WID for the SON/MDT WI:
Depending on the progress of the work, the following objective may be discussed in the later part of the WI:
NR-U related SON/MDT optimization which aims to reuse e.g. the existing NR-U measurements [RAN3, RAN2]
We believe that the SON/MDT WI is progressing well and that the time is ripe to open discussions on the subject of NR-U. In this paper we present some areas that would be interesting to explore as part of SON for NR-U.

### DISCUSSION

During RAN3-110e a proposal was already brought up with respect to SON for NR-U in R3-205952, Load information enhancements (Nokia, Nokia Shanghai Bell).
There is merit in investigating how Mobility Load Balancing can be applied to NR-U, given that NR-U is based on the use of unlicensed spectrum.
In NR-U the use of Listen-before-talk (LBT) is made, to determine whether the unlicensed spectrum channel can be accessed.
LBT is designed for unlicensed spectrum co-existence with other RATs. In this mechanism, a radio device applies a clear channel assessment (CCA) check (i.e. channel sensing) before any transmission. The transmitter involves energy detection (ED) over a time period compared to a certain threshold (ED threshold) in order to determine if a channel is idle.
LBT parameter settings (including ED) may be set for devices in a network by a network node configuring the devices in the network. The limits may be set as pre-defined rules or tables in specifications or regulatory requirements for operation in a certain region. Such limits are part of the ETSI harmonized standard in Europe as well as the 3GPP specification for operation of LTE/NR-U in unlicensed spectrum.
A device that wants to gain access to an NR-U channel needs to run the LBT process. If measurements on the channel determine that the power detected over the channel is higher than the configured thresholds, the channel is deemed accessible, otherwise the channel is deemed occupied and if cannot be access.
It is therefore immediately clear that determining the resources available for a RAN node using NR-U needs to take into account channel availability.
The following aspects should be taken into account when defining a solution for load information reporting for NR-U:
Reporting an indication per channel, over time, of when channel resources are available and when channel resources are un-available
Reporting what resource availability exists during the time share when the channel resources are available
Reporting the LBT configuration according to which a node determined that the channel is available or occupied
Reporting measurements indicating the overall energy level (or interference level) over the channel when available
Reporting the NR-U channels in operation at the reporting node/cell, for example the channels that have been in operation within a given time window before reception of the request for load information
Reporting the NR-U configuration, e.g. the ED threshold, in use in UL by the devices communicating with the reporting node
   The proposals above have the goal achieving an understanding of the NR-U channel conditions at the node reporting the load information, not only in terms of understanding the resources available at the node/cell, but also in terms of deriving the quality of the radio environment when resources are accessible.
   Proposal 1: It is proposed to discuss the topic of MLB for NR-U and to find solutions that lead to knowledge of resource availability and quality of radio environment for an NR-U channel
   Further, as part of SON, RAN3 should consider solutions for the coordination of NR-U configurations across different RAN nodes.
   It was mentioned above that an ED threshold is used in NR-U to determine whether a channel is available or occupied. The optimal selection of the ED threshold is largely dependent on the deployment scenario (indoor, outdoor, etc.), the load situation, the existence of external uncontrolled interferer, and many other factors. The selection of ED thresholds by a device has a direct impact on the inter-cell interference and therefore, on the coexistence and achievable performance. An operator, controlling a certain set of cells within the same area, can configure the ED threshold for each device in a centralized or distributed manner in order to improve the coexistence between those devices. However, in unlicensed spectrum, existence of other inter-/intra technology devices operating on the same unlicensed spectrum cannot be ruled out. Currently there is no means of communication to figure out the LBT parameters (such as ED threshold) used by a neighboring node and therefore the coexistence and sharing is always suboptimal.
   The above calls for solutions on inter RAN node coordination of NR-U configurations. Some areas that could be explored are:
Exchanging LBT mode configuration on a per channel basis between RAN nodes
Exchanging information about the NR-U channels in use and information such as rate of successful/unsuccessful access to them
Exchanging ED threshold information on a per channel basis
Exchanging RSSI measurements on a per channel basis over an observation period.
Allowing a RAN node to adapt its LBT configuration on the basis of the NR-U information received from neighbour RAN nodes
Allowing a RAN node to request the modification of a neighbour RAN node LBT configuration with the aim to increase NR-U channel efficiency
   Proposal 2: It is proposed to discuss the topic of cross RAN node coordination for NR-U and to find solutions that lead to an optimised NR-U configuration for more efficient channel utilisation
   Other areas within the topic of NR-U may be of relevance and interest when developed under the umbrella of SON. It is therefore proposed to open the AI on NR-U and to allow companies to bring forward their views on how NR-U can be optimised
   Proposal 3: It is proposed to open the AI on NR-U and to allow companies to bring forward their views on how NR-U can be optimised

### CONCLUSION

In this paper a view of NR-U and how SON could be applied to it has been given. The following proposals were made:
Proposal 1: It is proposed to discuss the topic of MLB for NR-U and to find solutions that lead to knowledge of resource availability and quality of radio environment for an NR-U channel
Proposal 2: It is proposed to discuss the topic of cross RAN node coordination for NR-U and to find solutions that lead to an optimised NR-U configuration for more efficient channel utilisation
Proposal 3: It is proposed to open the AI on NR-U and to allow companies to bring forward their views on how NR-U can be optimised

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the following claims.

1. A method performed by a first radio access network (RAN) node, the method comprising:
receiving, from a second RAN node, load metrics associated with a shared channel and listen-before-talk (LBT) configuration information, the LBT configuration information indicating how a determination is made whether the shared channel is occupied or available for communication between the second RAN node and a wireless device;
performing one or more operations of the first RAN node based at least in part on the load metrics and the LBT configuration information received from the second RAN node.

2. The method of claim 1, wherein the one or more operations comprise adapting an LBT configuration of the first RAN node.

3. The method of claim 1, wherein the one or more operations comprise determining a load status of the second RAN node based on the load metrics and the LBT configuration information received from the second RAN node.

4. The method of claim 3, wherein the one or more operations further comprise performing load balancing with the second RAN node based on the load status determined for the second RAN node.

5. The method of claim 1, wherein the one or more operations further comprise sending the second RAN node a request to change an LBT configuration of the second RAN node.

6. The method of claim 1, wherein the load metrics and the LBT configuration information are received in response to sending the second RAN node a request to provide the load metrics and the LBT configuration information.

7. The method of claim 1, wherein:
the load metrics associated with the shared channel include load metrics for communication on a downlink from the second RAN node to the wireless device; and
the LBT configuration information indicates how the determination is made whether the shared channel is occupied or available for communication on the downlink.

8. The method of claim 1, wherein:
the load metrics associated with the shared channel include load metrics for communication on an uplink from the wireless device to the second RAN node; and
the LBT configuration information indicates how the determination is made whether the shared channel is occupied or available for communication on the uplink.

9. The method of claim 1, wherein the LBT configuration information comprises a channel access configuration for the shared channel, the channel access configuration including an energy detection (ED) threshold configuration.

10. The method of claim 1, wherein the shared channel uses unlicensed spectrum and is shared by the second RAN node and at least one other node, wherein the at least one other node uses a different radio access technology than the second RAN node.

11. A method performed by a second radio access network (RAN) node, the method comprising:
determining load metrics associated with a shared channel and listen-before-talk (LBT) configuration information, the LBT configuration information indicating how a determination is made whether the shared channel is occupied or available for communication between the second RAN node and a wireless device; and
sending the load metrics and the LBT configuration information to a first RAN node.

12.-16. (canceled)

17. A first radio access network (RAN) node, the first RAN node comprising:
power supply circuitry configured to supply power to the first RAN node; and
processing circuitry configured to:
receive, from a second RAN node, load metrics associated with a shared channel and listen-before-talk (LBT) configuration information, the LBT configuration information indicating how a determination is made whether the shared channel is occupied or available for communication between the second RAN node and a wireless device;
perform one or more operations of the first RAN node based at least in part on the load metrics and the LBT configuration information received from the second RAN node.

18. The first RAN node of claim 17, wherein the one or more operations comprise adapting an LBT configuration of the first RAN node.

19. The first RAN node of claim 17, wherein the one or more operations comprise determining a load status of the second RAN node based on the load metrics and the LBT configuration information received from the second RAN node.

20. The first RAN node of claim 19, wherein the one or more operations further comprise performing load balancing with the second RAN node based on the load status determined for the second RAN node.

21. The first RAN node of claim 17, wherein the one or more operations further comprise sending the second RAN node a request to change an LBT configuration of the second RAN node.

22. The first RAN node of claim 17, wherein the processing circuitry is further configured to send the second RAN node a request to provide the load metrics and the LBT configuration information, and wherein the load metrics and the LBT configuration information are received in response to sending the request.

23. The first RAN node of claim 17, wherein:
the load metrics associated with the shared channel include load metrics for communication on a downlink from the second RAN node to the wireless device; and
the LBT configuration information indicates how the determination is made whether the shared channel is occupied or available for communication on the downlink.

24. The first RAN node of claim 17, wherein:
the load metrics associated with the shared channel include load metrics for communication on an uplink from the wireless device to the second RAN node; and
the LBT configuration information indicates how the determination is made whether the shared channel is occupied or available for communication on the uplink.

25. The first RAN node of claim 17, wherein the LBT configuration information comprises a channel access configuration for the shared channel, the channel access configuration including an energy detection (ED) threshold configuration.

26. A second radio access network (RAN) node, the second RAN node comprising:
power supply circuitry configured to supply power to the second RAN node; and
processing circuitry configured to:
determine load metrics associated with a shared channel and listen-before-talk (LBT) configuration information, the LBT configuration information indicating how a determination is made whether the shared channel is occupied or available for communication between the second RAN node and a wireless device; and
send the load metrics and the LBT configuration information to a first RAN node.

27. The second RAN node of claim 26, wherein the processing circuitry is further configured to:
receive, from the first RAN node, a request to change an LBT configuration of the second RAN node; and
in response to the request, change the LBT configuration of the second RAN node.

28. The second RAN node of claim 26, wherein the processing circuitry is further configured to:
receive, from the first RAN node, a request to provide the load metrics and the LBT configuration information;
wherein the load metrics and the LBT configuration information are sent to the first RAN node in response to receiving the request.

29. The second RAN node of claim 26, wherein:
the load metrics associated with the shared channel include load metrics for communication on a downlink from the second RAN node to the wireless device; and
the LBT configuration information indicates how the determination is made whether the shared channel is occupied or available for communication on the downlink.

30. The second RAN node of claim 26, wherein:
the load metrics associated with the shared channel include load metrics for communication on an uplink from the wireless device to the second RAN node; and
the LBT configuration information indicates how the determination is made whether the shared channel is occupied or available for communication on the uplink.

31. The second RAN node of claim 26, wherein the LBT configuration information comprises a channel access configuration for the shared channel, the channel access configuration including an energy detection (ED) threshold configuration.
